(19) United States
(12) Patent Application Publication
(10) Pub. No.: US 2023/0309035 A1
(43) Pub. Date: Sep. 28, 2023

(54) SYNCHRONIZATION METHOD AND APPARATUS FOR TIME SENSITIVE NETWORKING IN A MOBILE COMMUNICATION SYSTEM

(71) Applicant: Samsung Electronics Co., Ltd., Gyeonggi-do (KR)

(72) Inventor: Sangjun MOON, Gyeonggi-do (KR)

(21) Appl. No.: 18/127,169

(22) Filed: Mar. 28, 2023

(30) Foreign Application Priority Data
Mar. 28, 2022 (KR) 10-2022-0038432

(51) Int. Cl. H04W 56/00

(52) U.S. Cl. CPC H04W 56/001; H04W 56/006

(57) ABSTRACT

The disclosure relates to a 5G or 6G communication system for supporting higher data transmission rates. A method is provided for a first entity that performs a TSCTSF in a wireless communication system. The method includes receiving, from an entity that performs an external application function (AF), a first 5GS synchronization request message including information for performing 5GS synchronization; obtaining location information of a terminal to perform the 5GS synchronization; and determining whether to support a 5GS synchronization service based on the first 5GS synchronization request message and the location information of the terminal to perform the synchronization.

### CROSS-REFERENCE TO RELATED APPLICATION(S)

This application is based on and claims priority under 35 U.S.C. § 119(a) to Korean Patent Application No.: 10-2022-0038432, which was filed in the Korean Intellectual Property Office on Mar. 28, 2022, the entire disclosure of which is incorporated herein by reference.

### BACKGROUND

### 1. Field

The disclosure relates generally to operations of a terminal and a base station in a wireless communication system, and more particularly, to a method and apparatus for implementing time sensitive networking (TSN) in a mobile communication system, and for providing time synchronization between wireless terminals in a 3^{rd} generation partnership project (3GPP) 5th generation (5G) system.

### 2. Description of Related Art

5G mobile communication technology defines a wide frequency band that enables fast transmission speed and new services, and can be implemented in frequency bands below 6 GHz (‘sub 6 GHz’) such as 3.5 GHz, as well as in ultra-high frequency bands (‘above 6 GHz’), such as 28 GHz and 39 GHz, which may be referred to as mmWave. In addition, for 6th generation (6G) mobile communication technology, which may also referred to as beyond-5G systems, in order to accomplish a transmission rate that is 50 times as fast as 5G communication systems and an ultra-low latency having a 1/10 radio latency of 5G, it has been considered to implement 6G mobile communication technology in a terahertz band (e.g., 95 GHz to 3 THz bands).

Since the implementation of 5G mobile communication technology, with the goal of service support and satisfaction of performance requirements for enhanced mobile broadband (eMBB), ultra-reliable low-latency communications (URLLC), and massive machine-type communications (mMTC), standardization is in progress for beamforming and massive multiple input multiple output (MIMO) to relieve a path loss of a radio wave and increase a transmission distance of the radio wave in the ultra-high frequency band, support of various numerologies (e.g., operation of a plurality of subcarrier spacings or the like) and dynamic operation for slot formats for efficient utilization of ultra-high frequency resources, initial access technology for supporting multiple beam transmission and broadband, definition and operation of bandwidth part (BWP), new channel coding methods such as low density parity check (LDPC) codes for massive capacity data transmission and polar codes for reliable transmission of control information, layer 2 (L2) pre-processing, network slicing that provides a dedicated network specialized for a specific service, etc.

Currently, discussions are underway to improve and enhance the initial 5G mobile communication technology in consideration of services that the 5G mobile communication technology is intended to support, and physical layer standardizations are in progress for technologies such as vehicle-to-everything (V2X) to help determine the driving of an autonomous vehicle based on its own location and state information transmitted by the vehicle and increase user convenience, new radio unlicensed (NR-U) for the purpose of system operation that meets various regulatory requirements in unlicensed bands, NR terminal low power consumption technology (e.g., user equipment (UE) power saving), a non-terrestrial network (NTN) that is direct terminal-satellite communication to secure coverage in areas where communication with the terrestrial network is impossible, positioning, etc.

In addition, standardization is in progress in the field of air interface architecture/protocol for technologies such as intelligent factories (e.g., industrial Internet of things (IIoT)) for supporting new services through linkage and convergence with other industries, integrated access and backhaul (IAB) that provides nodes for network service area expansion by integrating and supporting wireless backhaul links and access links, mobility enhancement including conditional handover and dual active protocol stack (DAPS)handover, 2-step random access (RACH for NR) that simplifies the random access procedure, etc. In addition, standardization is in progress in the field of system architecture/service such as 5G baseline architecture (e.g., service based architecture, or service based interface) for combining network functions virtualization (NFV) and software-defined networking (SDN), mobile edge computing (MEC) that receives services based on the location of the device, etc.

When such a 5G mobile communication system is commercialized, the number of devices that will be connected to the communication network will increase, and accordingly, it is expected that the function and performance enhancements of the 5G mobile communication system and the integrated operation of connected devices will be required. To this end, new researches is being conducted on extended reality (XR) for efficiently supporting augmented reality (AR), virtual reality (VR), mixed reality (MR), 5G performance improvement and complexity reduction using artificial intelligence (AI) and machine learning (ML), AI service support, metaverse service support, drone communication, etc.

In addition, the development of these 5G mobile communication systems will be based on the development of next-generation distributed computing technology that may be realized by utilizing new waveforms to ensure coverage in the terahertz band of 6G mobile communication technology, full dimensional (FD)-MIMO, array antennas, multi-antenna transmission technologies such as large scale antennas, metamaterial-based lenses and antennas to improve coverage of terahertz band signals, high-dimensional spatial multiplexing technology using orbital angular momentum (OAM), reconfigurable intelligent surface (RIS) technology, full duplex technology to improve frequency efficiency and system network of 6G mobile communication technology, satellite, AI from the design stage, and utilizing AI-based communication technology that realizes system optimization by internalizing end-to-end AI support functions, and ultra-high-performance communication and computing resources for services of complexity that exceed the limits of terminal computing capabilities, etc.

As a mobile communication system provides high-speed data processing, the mobile communication system itself can be implemented as one node of a TSN system.

On the other hand, data transmission in the mobile communication system may be considered by dividing it into transmission in a core network inside the mobile communication system, transmission from the core network to a base station and transmission from the base station to a terminal, e.g., a UE. The transmission in the core network and the transmission from the core network to the base station are generally implemented as a wired transmission. However, the transmission from the base station to the terminal is generally implemented as a wireless transmission. Therefore, the transmission in the wireless section takes longer than the transmission in the wired section. In addition, in the mobile communication system, the coverage of the base station is different for each base station. In addition, data transmission time may vary depending on the distance from the base station to the terminal. Therefore, the coverage per base station and the distance from the base station to the terminal should be considered when supporting TSN in the mobile communication system.

### SUMMARY

An aspect of the disclosure is to provide a method and apparatus capable of effectively providing a service in a mobile communication system.

Another aspect of the disclosure is to provide a method and apparatus for providing a synchronization service based on a coverage when supporting TSN in a mobile communication system.

In accordance with an aspect of the disclosure, a method is provided for a first entity that performs a time sensitive communication time synchronization function (TSCTSF) in a wireless communication system. The method includes receiving, from an entity that performs an external application function (AF), a first 5G service (5GS) synchronization request message including information for performing 5GS synchronization; obtaining location information of a terminal to perform the 5GS synchronization; and determining whether to support a 5GS synchronization service based on the first 5GS synchronization request message and the location information of the terminal.

In accordance with another aspect of the disclosure, a method is provided for a second entity that performs an access and mobility management function (AMF) in a wireless communication system. The method includes receiving, from a first entity that performs a TSCTSF, a request message for location information of a terminal; transmitting, to the first entity that performs the TSCTSF, the location information of the terminal to perform 5GS synchronization via a response message for the location information of the terminal; receiving, from a third entity that performs a policy control management function (PCF), a second 5GS synchronization request message; and determining whether to perform a 5GS synchronization service for the terminal based on the location information of the terminal to perform the 5GS synchronization.

In accordance with another aspect of the disclosure, a first entity is provided that performs a TSCTSF in a wireless communication system. The first entity includes a transceiver; and a controller, wherein the controller receives, from an entity that performs an external AF, a first 5GS synchronization request message including information for performing 5GS synchronization, obtains location information of a terminal to perform the 5GS synchronization, and determines whether to support a 5GS synchronization service based on the first 5GS synchronization request message and the location information of the terminal to perform synchronization.

In accordance with another aspect of the disclosure, a second entity is provided that performs an AMF in a wireless communication system. The second entity includes a transceiver; and a controller, wherein the controller receives, from a first entity that performs a TSCTSF, a request message for location information of a terminal, transmits, to the first entity that performs the TSCTSF, the location information of the terminal to perform 5GS synchronization via a response message for the location information of the terminal, receives, from a third entity that performs a PCF, a second 5GS synchronization request message, and determines whether to perform a 5GS synchronization service for the terminal based on the location information of the terminal to perform the 5GS synchronization.

### BRIEF DESCRIPTION OF THE DRAWINGS

The above and other aspects, features, and advantages of certain embodiments will be more apparent from the following description taken in conjunction with the accompanying drawings, in which:

FIG. 1 illustrates time synchronization on an ethernet using TSN according to an embodiment;

FIG. 2 illustrates TSN time synchronization by a 5G network according to an embodiment;

FIG. 3 illustrates a method for supporting a TSN time synchronization by a 5G network with an existing technology according to an embodiment;

FIG. 4 illustrates a time synchronization support process through a 3GPP network according to an embodiment;

FIG. 5 illustrates a method for configuring 5GS as a synchronization source according to an embodiment;

FIG. 6 illustrates a synchronization service for configuring 5GS as a synchronization source being applied with different accuracies according to a terminal position according to an embodiment;

FIG. 7 illustrates a method in which a 5G core (5GC) notifies an AF (TSCTSF/unified data management (UDM)/user data repository (UDR)/AMF/session management function (SMF)) of a request and the AF (TSCTSF/UDM/UDR/AMF/SMF) transmits the request to a UE through session management (SM)non access stratum (NAS) according to an embodiment;

FIG. 8 illustrates a method in which a 5GC notifies an AF (TSCTSF/UDM/UDR/AMF) of a request and the AF (TSCTSF/UDM/UDR/AMF) transmits the request to a UE through an access and mobility management (AM) NAS according to an embodiment;

FIG. 9 illustrates a method in which a 5GC notifies an AF (TSCTSF/UDM/UDR/AMF) of a request and the AF (TSCTSF/UDM/UDR/AMF) transmits the request to a UE through access stratum (AS)(system information block (SIB) or radio resource control (RRC) signaling) according to an embodiment;

FIG. 10 illustrates a method in which a 5GC notifies an AF of a request and the AF transmits the request to a UE through a user plane (UP) according to an embodiment;

FIG. 11 illustrates a method in which a 5GC notifies a TSCTSF/network exposure function (NEF) of a request and the TSCTSF/NEF transmits the request to a UE through SM NAS according to an embodiment;

FIG. 12 illustrates a method in which a 5GC notifies a TSCTSF/NEF of a request and the TSCTSF/NEF transmits the request to a UE through AM NAS according to an embodiment;

FIG. 13 illustrates a method in which a 5GC notifies a TSCTSF/NEF of a request and the TSCTSF/NEF transmits the request to a UE through AS (SIB or RRC signaling) according to an embodiment;

FIG. 14 illustrates a method in which a 5GC notifies UDM/UDR of a request and the UDM/UDR transmits the request to a UE through SM NAS according to an embodiment;

FIG. 15 illustrates a method in which a 5GC notifies UDM/UDR of a request and the UDM/UDR transmits the request to a UE through AM NAS according to an embodiment;

FIG. 16 illustrates a method in which a 5GC notifies UDM/UDR of a request and the UDM/UDR transmits the request to a UE through AS (SIB or RRC signaling) according to an embodiment;

FIG. 17 illustrates a method in which a 5GC notifies an AF of a request and the AF transmits the request to a UE through SM NAS according to an embodiment;

FIG. 18 illustrates a method in which a 5GC notifies an AF of a request and the AF transmits the request to a UE through AM NAS according to an embodiment;

FIG. 19 illustrates a method in which a 5GC notifies an AF of a request and the AF transmits the request to a UE through AS (SIB or RRC signaling) according to an embodiment;

FIG. 20 illustrates a method in which a 5GC notifies an AF of a request and the AF transmits the request to a UE through a UP according to an embodiment;

FIG. 21 illustrates a method in which a 5GC notifies an AMF/SMF of a request and the AMF/SMF transmits the request to a UE through SM NAS according to an embodiment;

FIG. 22 illustrates a method in which a 5GC notifies an AMF/SMF of a request and the AMF/SMF transmits the request to a UE through AM NAS according to an embodiment;

FIG. 23 illustrates a method in which a 5GC notifies an AMF/SMF of a request and the AMF/SMF transmits the request to a UE through an AS (SIB or RRC signaling) according to an embodiment;

FIG. 24 is illustrates a network function (NF) of a wireless communication network according to an embodiment; and

FIG. 25 illustrates a UE according to an embodiment.

### DETAILED DESCRIPTION

Hereinafter, various embodiments of the disclosure will be described in detail with reference to the accompanying drawings.

In the following description of the disclosure, detailed description of known functions or structures may be omitted when it is deemed that they may unnecessarily obscure the essence of the disclosure. Also, terms used below are defined in consideration of functions in the disclosure, and may have different meanings according to an intention of a user or operator, customs, etc. Thus, the terms should be defined based on the description throughout the specification.

In the following description, terms used to identify an access node, terms referred to as network entities, terms expressing messages, terms representing interfaces between network objects, terms used for various types of identification information, etc., are used for the sake of convenient description. Therefore, the disclosure is not limited by the terms and may use other terms with the meanings equivalent to the terms described in the disclosure, representing the corresponding components.

Hereinafter, for convenience of description, the disclosure uses terms and names defined in 5GS and NR standards of the 3GPP organization. However, the disclosure is not limited by these terms and names, and may be equally applied to a wireless communication network conforming to other standards. For example, the disclosure is also applicable to 3GPP 5GS/NR (i.e., a 5G mobile communication standard).

In the case that a mobile communication system is used in an application such as a smart grid, an accurate time synchronization is required. Generally, a synchronization service may only be provided to a certain area. If a terminal leaves the certain area, the mobile communication system may not need to provide the service, or may need to apply other types of synchronization services.

In addition, accurate time synchronization between terminals for factory automation is often required. For example, accurate time synchronization between terminals may be required when applying audio/video sharing.

Herein, the terms “terminal” and “UE” may be used interchangeably. In addition, the abbreviation of TSN may refer to both a time sensitive network and time sensitive networking, which may be used interchangeably without any distinction.

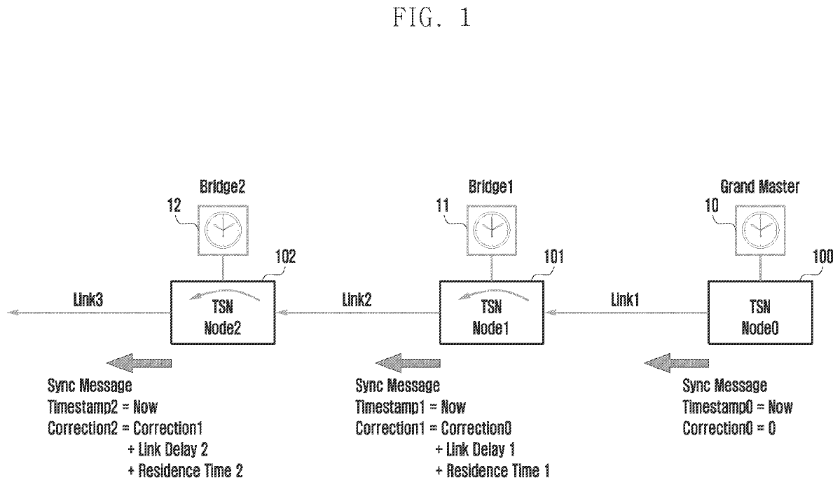

FIG. 1 illustrates time synchronization on an ethernet using TSN according to an embodiment.

Referring to FIG. 1, three different nodes 100, 101, and 102 are connected in series with ethernet.

More specifically, a first node TSN Node0 100 transmits a synchronous message (sync message), and a second node TSN Node1 101 relays the sync messages transmitted from the TSN Node0 100, a third node TSN Node2 102 may be a final destination node or a relay node like the TSN Node 1 101. The TSN Node0 100 may transmit the sync message using a grand master (GM) clock 10. A first link between the TSN Node0 100 and the TSN Node1 101 may be called Link1, a second link between the TSN Node1 101 and the TSN Node2 102 may be called Link2, and a third link between the TSN Node2 102 and subsequent nodes (if present) may be called Link3.

The nodes of each TSN may determine GM clocks 10, 11, and 12 that become the standard. The TSN Node0 100 connected to the GM clock 10 may generate a synchronization (sync) frame by inputting the current time to a TIMESTAMP field and filling a correction field with zero. The TSN Node0 100 may transmit the generated sync frame to a next node, i.e., TSN Node1 101.

The TSN Node1 101 may receive the sync frame, in which Link Delay 1 occurs, from the TSN node0 100, and may update the correction field in consideration of Residence Time1, i.e., a time in which the TSN node1 101 resides in its own node. Then, the TSN Node 1 101 may transmit the sync frame with the updated correction field to the next node, i.e., TSN node2 102.

The TSN node2 102 may receive the sync frame, in which Link Delay 2 occurs, from the TSN node1 101, and may update again the correlation field in consideration of Residence Time2, i.e., a time in which the TSN node2 resides in its own node. The TSN Node2 102 may transmit the sync frame updated at itself to the next node. The respective nodes may periodically measure a delay time by a link with the previous node, and calculate and manage an average of the delay times. Further, the respective nodes may calculate the residence time in their own nodes.

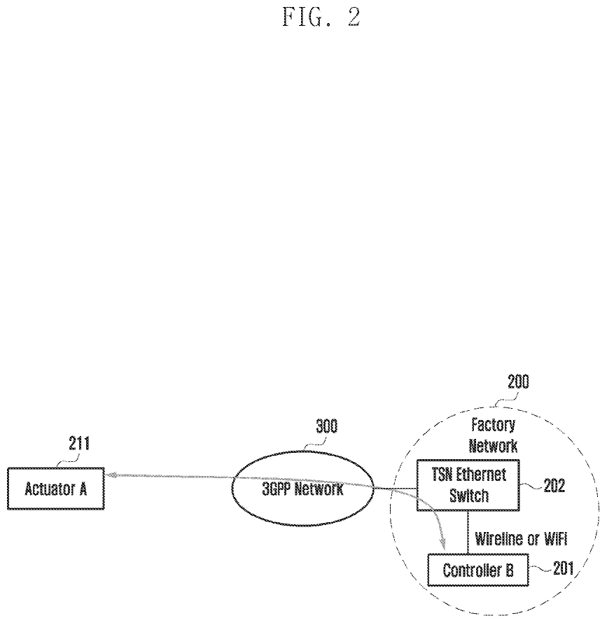

FIG. 2 illustrates TSN time synchronization by a 5G network according to an embodiment.

Referring to FIG. 2, a factory network 200 includes a TSN Ethernet switch 202 and a controller B 201. In addition, a 3GPP network 300 operates as an ethernet node between the factory network 200 and an actuator.

The 3GPP network 300 may be capable of satisfying a time delay condition, which is a requirement of TSN of an ethernet network. For example, the 3GPP network 300 may be capable of transmitting high-speed data like a 5G network. In addition, the 3GPP network 300 may be a 5G network as well as a 6G network for which standardization is currently being discussed.

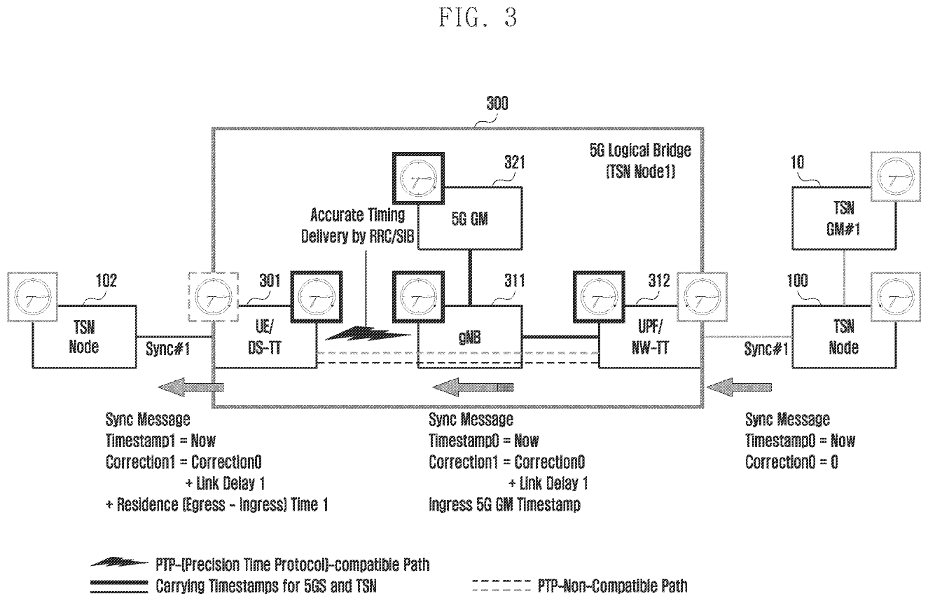

FIG. 3 illustrates a method for supporting a TSN time synchronization by 5G.

Referring to FIG. 3, a UP function (UPF) 312 that transmits user data within the 5G network may include a network side TSN translator (NW-TT) internally or physically connected to the UPF 312.

In addition, data transmitted to a UP may be provided to a UE 301 through a base station of the 5G network 300, i.e., a gNB 311. Herein, the gNB 311 may be used interchangeably with a new generation (NG)-radio access network (RAN), a RAN, an access network (AN), a (R)AN, etc.

The UE 301 may include a device side (DS)-TSN Translator (TT) internally or directly physically connected to the UE 301 to process the TSN described in the disclosure. Herein, the UE 301 may be used interchangeably with a terminal, and either term may refer to an electronic device capable of communicating with the 5G network. Additionally, the UE 301 or terminal may be referred to as a mobile terminal, a smart phone, an access terminal, etc.

In the following description, it is assumed that the 3GPP network is the 5G network, for example. Therefore, the 3GPP network and the 5G network may be used interchangeably. In addition, it is obvious to those skilled in the art that the 3GPP network in the disclosure described below may be replaced with the 5G network or other mobile communication networks that can satisfy the time delay required by TSN.

As described above, the UPF(/NW-TT) 312-gNB 311-UE(/DS-TT) 301 may update the sync frame in the 3GPP network 300 by correcting the link delay and the residence time as one TSN node, thereby supporting the TSN. To this end, it is assumed that the UPF(/NW-TT) 312, the gNB 311, and the UE(/DS-TT) 301 within the 5G Network are synchronized with a common 5G GM 321. For example, the gNB 311 is connected to a global positioning system (GPS), the UPF(/NW-TT) 301 is connected to the gNB 311 through ethernet-based TSN to synchronize with the gNB 311, and the UE(/DS-TT) 301 may be synchronized with the gNB 311 by exchanging a physical frame (PHY Frame). The UPF(/NW-TT) 312 is connected to the TSN node of a wired network, and the UE(/DS-TT) 301 may also be connected to the TSN node of a wired network.

Since FIG. 3 illustrates TSN GM #1 10 in the TSN node 100 connected to the UPF(/NW-TT) 312, the UPF(/NW-TT) 312 receives the sync frame from a previous TSN node 100. The UPF 312 records an ingress time, which is a time based on the 5G GM 321 of the received sync frame. The UPF(/NW-TT) 312 periodically calculates and manages the link delay with the previous TSN node 100. The UPF(/NW-TT) 312 transmits the sync frame including the ingress time and the link delay to the UE 301. The UE(/DS-TT) 301 calculates the residence time, which is the residence time in the 5G Network 300, based on the 5G GM 321 standard time at the moment when the sync frame is transmitted to the next TSN node. The UE(/DS-TT) 301 transmits the sync frame to the next TSN node 102 by updating the correction field using the residence time and the link delay.

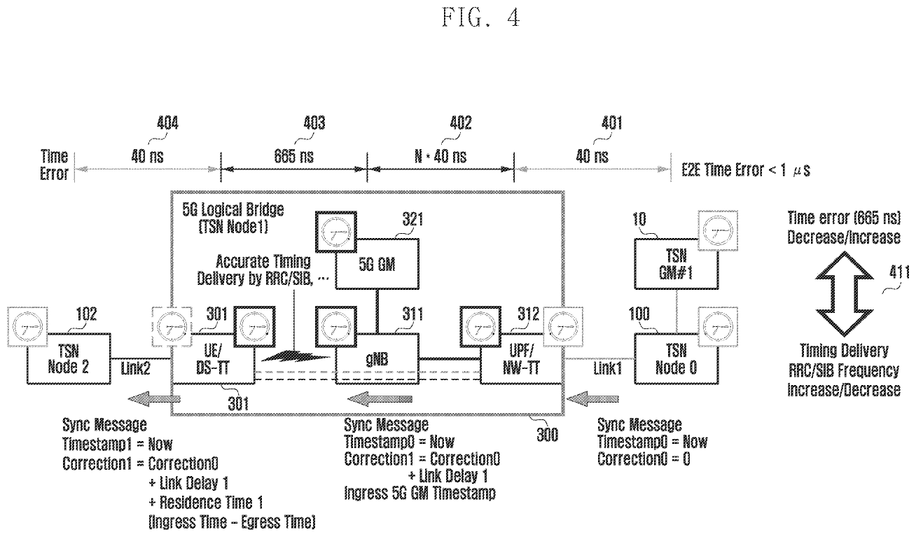

FIG. 4 illustrates a time synchronization support process through a 3GPP network according to an embodiment.

Referring to FIG. 4, in order to support TSN synchronization in the 3GPP network 300, the 3GPP network 300 operates as one TSN node. Accordingly, all entities in the 3GPP network 300 should be synchronized to the 5G GM clock 321. For this purpose, it is assumed that the gNB 311 is connected to the 5G GM 321, and the UPF 312 connected to the gNB 311 by the wired network also uses a wired network TSN synchronization scheme or is synchronized to the 5G GM clock 321 using other schemes. The gNB 311 and the UE 301 are connected through a 5G wireless protocol (air protocol), and in this process, in order to precisely support synchronization with the UE 301, the gNB 311 should additionally provide several functions so that the time error is less than 656 ns, as illustrated in reference numeral 403, for example. Examples of functions that should be additionally provided may include accurate timing delivery by an RRC/SIB, finer timing advance (TA) granularity, propagation delay compensation, etc.

In a synchronization process (or downlink synchronization) in a downlink direction, if all entities in the 3GPP network 300 are synchronized to the 5G GM clock 312, when the UPF 312 receives the sync frame, the UPF 312 may include an ingress time stamp based on the 5G GM clock 312 and a link delay with the previous TSN node 100 that is measured/calculated and managed in the sync frame and transmit the sync frame to the UE 301 through the gNB 311. The UE 301 may calculate a time that transmits the sync frame to an external TSN node based on the 5G GM clock 321, calculate a difference between the time and an ingress time, and reflect the difference as a residence time to the correction field, thereby completing a TSN synchronization operation.

For uplink synchronization, the UE 301 may include the ingress time, which is a time based on the 5G GM that has received a sync frame from the previous TSN node, and a link delay with the previous TSN node in the sync frame and transmit the sync frame to the UPF 312 through the gNB 311. Accordingly, the UPF 312 may calculate a time that transmits the sync frame to an external TSN node, based on the 5G GM clock 321, calculate a difference between the time and the ingress time, and reflect the difference as a residence time to the correction field. Through such a process, the 3GPP network 300 may maintain a TSN synchronization time error to less than 1 μs.

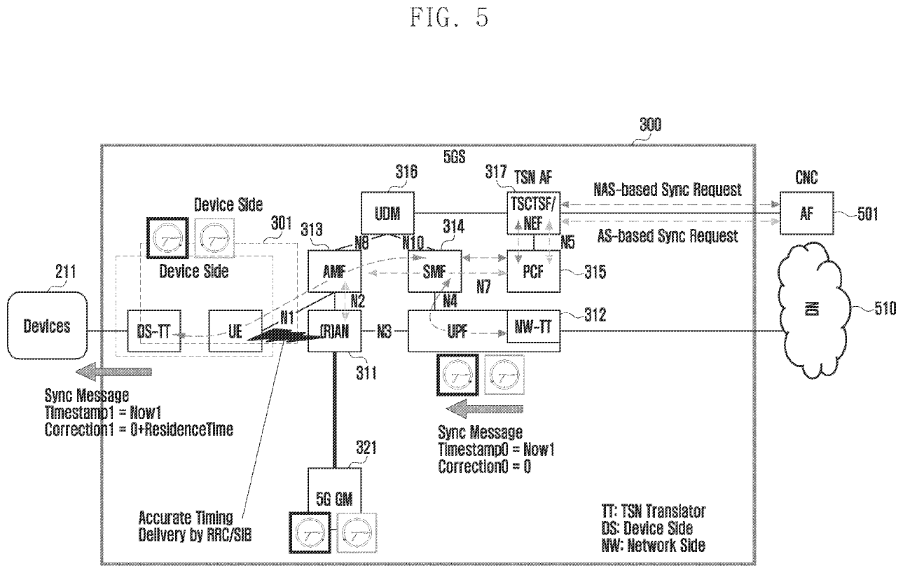

FIG. 5 illustrates a method for configuring a 5GS as a synchronization source according to an embodiment.

When comparing FIG. 5 with FIGS. 2 to 4 described above, the internal configuration of the 5G network 300 in FIG. 5 may be the same as those in FIGS. 2 to 4 and may include additional components. The additional components may be included in the 5G network 300 or components that are not illustrated for convenience of description in FIGS. 2 to 4.

Referring to FIG. 5, an AMF 313 may perform an NF of managing the mobility of the UE 301. An SMF 314 may perform an NF of managing a packet data network connection provided for the UE 301. This connection may be referred as a protocol data unit (PDU) session. A PCF 315 may perform an NF of applying a mobile network operator's service policy, charging policy, and policy for a PDU session on the UE 301. A UDM 316 may perform an NF of storing information about a subscriber. An NEF 317 can access information for managing the UE 301 in the 5G network, thus subscribing to a mobility management event of the UE 301, subscribing to an SM event of the UE 301, requesting session-related information, configuring charging information about the UE 301, and requesting a change of a PDU session policy on the UE 301. In addition, the NEF 317 illustrates a case implemented as one NF together with a TSCTSF.

In FIG. 5, although the same reference numeral is used for the device 211 as is used for the actuator 211 in FIG. 2 described above, the device 211 is not necessarily limited to the actuator 211 and may be one of TSN termination devices.

In FIG. 5, a centralized network configuration (CNC) server 501 may be provided in the form of an AF. For example, in the case that the 5GS 300 interlocks with the TSN system, a TSN AF may interlock with the CNC server 501 and exchange management information with the CNC server 501. The TSN AF may read the management information out of the NW-TT 312 and the DS-TT, and change the configuration by transmitting the management information to the NW-TT 312 and the DS-TT.

If there is no TSN AF, the 5GS 300 may interlock with an external AF through TSCTSF/NEF 317. In this case, the TSCTSF/NEF 317 may perform a similar function as that performed by the TSN AF. The TSCTSF/NEF 317 may exchange the management information with the NW-TT 312 and the DS-TT. Further, the TSCTSF/NEF 317 may transmit the information of the 5GS 300 to the external AF 501 or interlock with SMF 314, AMF 313, PCF 315, and UDR 316 in order to apply requirements of the external AF 501 to the 5GS system. In particular, the TSCTSF/NEF 317 may store information in the UDR 316, and transmit updated information to UDM 316/UDR or the PCF 315 through a notification process. Here, a message to be delivered may be transmitted through a NAS-based message in the AMF 313. Therefore, this method may be called a NAS-based method.

The message according to the NAS-based method may be transmitted through AF 501-TSCTSF/NEF 317-PCF 315-SMF 314-AMF 313-UE 301 in the case that a management for the DT-TT of the UE 301 is required. Here, although an actual message is transmitted through the RAN 311, it should be noted that the RAN 311 is not stated in the messaging format because the RAN 311 plays a role of delivery on a layer being processed. In addition, in the case that a management for the UPF 312 is required, a control message may be transmitted through AF 501-TSCTSF/NEF 317-PCF 315-SMF 314-UPF 312.

Time synchronization between the terminals may be supported by transmitting an RRC or an SIB to the RAN 311 of the 5G to which the request of the AF 501 is applied. This process may include controlling the RAN synchronization function using RAN parameters. This method can be called an AS-based method. It is possible to increase the RRC/SIB transmission frequency for time information transmission to a level that satisfies accuracy. The base station 311 may control the time synchronization accuracy by measuring accurate delay time by controlling the period of exchanging messages for measuring the delay time between the specific terminal 301 and the base station through RRC. In addition, the base station may control the time synchronization accuracy by controlling the delivery period including time information in the information broadcast to all terminals through the SIB. In this AS-based method, a message may be transmitted through AF 501-TSCTSF/NEF 317-PCF 315-SMF 314-AMF 313-RAN 311-UE 301.

The AF request is either the NAS-based request or the AS-based request, but the AF cannot have information on the internal state of the 5GS, such as sync accuracy to be supported, the number of corresponding UEs, or whether the corresponding UE is idle/active. Therefore, even if the request of the AF 501 is based on the NAS, the 5GS synchronization may need to be processed based on the AS. Even if the request of the AF 501 is based on the AS, the 5GS synchronization may need to be processed based on the NAS. Alternatively, even if the request of the AF 501 is based on the NAS or the AS, both the 5GS synchronization based on the AS and the 5GS synchronization based on the NAS may need to be processed.

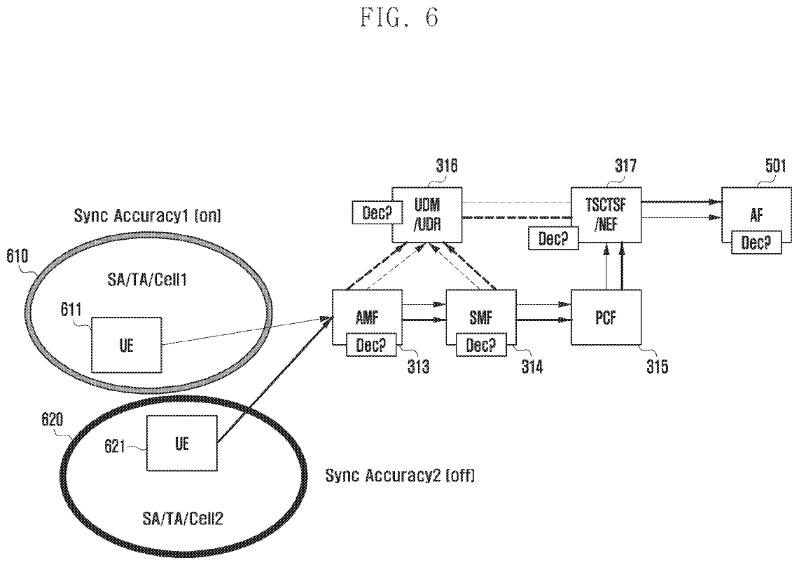

FIG. 6 illustrates a sync service for configuring a 5GS as a synchronization source being applied with different accuracies according to a location of a terminal according to an embodiment.

Referring to FIG. 6, respective cells (or base station areas) 610 and 620 of the 3GPP network supporting the TSN is illustrated. Each of the cells 610 and 620 includes UEs 611 and 621, respectively, for transmitting information on at least one TSN service. Also, the cells 610 and 620 may be different frequency bands of the same base station or different base stations. Hereinafter, for convenience of description, a case in which the cells are different base stations will be assumed and described.

In FIG. 6, the synchronization accuracy (sync accuracy) of a specific cell may be controlled by including an on/off situation. In addition, in FIG. 6, the location of the terminal may be used to control the synchronization accuracy (sync accuracy) of a specific cell. A request in the form of “Dec?” according to the cell coverage is illustrated for the network entities, which are subjects for determining whether to provide services based on the location of the terminal.

More specifically, the UE 611 connected to Cell 1, tracking area 1 or service area (SA) 1 610 transmits a registration message including information on the corresponding Cell/tracking area/SA to AMF 313 through the RAN. Based on how to utilize this UE location information, the 5GS time synchronization service may be configured in consideration of coverage. In addition, the methods described below may be combined and utilized.

Method A: The 5GC notifies the TSCTSF/NEF of a request message for a service, and the TSCTSF/NEF may determine whether to provide the service. This method can be advantageous in that the TSCTSF/NEF can determine the location of each terminal and the provision state of the synchronization service, and thus, can report this state to the AF if necessary. It is also an advantage that signaling for updating the state does not need to be generated every time for the external AF.

Method B: The 5GC notifies the UDM/UDR of a request message for a service, and the UDM/UDR may determine whether to provide the service. In this method, since the UDM/UDR manages the situation in which a policy is updated by the operation according to the location update of the terminal, a separate procedure must be additionally defined for the TSCTSF/NEF or the external AF to determine the location of each terminal and the provision state of the synchronization service.

Method C: The 5GC notifies the AF of a request message for a service, and the AF may determine whether to provide the service. This method has an advantage in that the AF requesting the synchronization service can determine the location of the terminal and the sync accuracy provided, but may it be burdensome to generate signaling for the AF every time.

Method D: The 5GC notifies the AMF/SMF of a request message for a service, and the AMF/SMF may determine whether to provide the service. In this method, the AMF/SMF maintains a plurality of policies according to conditions and additionally requires functions for performing operations accordingly. In addition, a separate procedure must be additionally defined for the TSCTSF/NEF or the external AF to determine the location of each terminal and the provision state of the synchronization service.

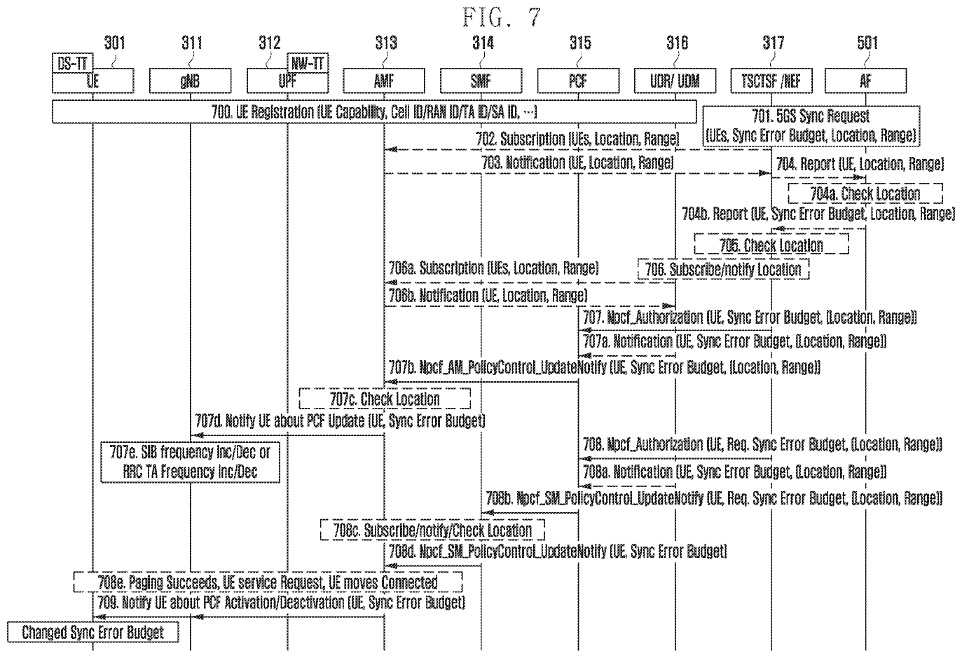

FIG. 7 illustrates a method in which a 5GC notifies an AF (TSCTSF/UDM/UDR/AMF/SMF) of a request and the AF (TSCTSF/UDM/UDR/AMF/SMF) transmits the request to a UE through SM NAS according to an embodiment.

More specifically, FIG. 7 illustrates a method in which a 5GC notifies an AF and the AF delivers SM to a terminal through NAS. The AF may include at least one of a TSCTSF, a UDM, a UDR, an AMF, or an SMF).

The components of the 3GPP network 300 in the disclosure described below will be described using the same or similar reference numerals in the described above. For example, reference numerals of the configurations illustrated in FIG. 5 will be used. In addition, in the following, a message delivered to the UE 301 through SM NAS may include a control message related to the delivery of the sync message.

Referring to FIG. 7, in step 700, the UE 301 transmits a registration message including UE Capability indicating that the UE may be supported by the 5GS synchronization service. The registration message may include a cell identifier (ID), a RAN ID, a tracking area ID, or an SA ID corresponding to where the UE 301 is located. Therefore, the NF receiving the registration message may derive the location of the UE from the cell ID, the RAN ID, the tracking area ID, or the SA ID. This information may be transmitted to the AMF 313 through the gNB 311 and may be stored in the UDR/UDM 316.

In step 701, the AF 501 transmits the 5GS synchronization request message for target UEs to a TSCTSF/NEF 317. The request message may include the required synchronization accuracy as a sync error budget. In addition, the request message may specify a coverage to which the synchronization service is applied as a location or range. The indication of the target UE may be indicated as a list of UE IDs, a group ID, data network name (DNN)/single network slice selection assistance information (S-NSSAI), etc.

In step 702, the TSCTSF/NEF 317 requests the AMF 313 to notify the location and range information of the target UEs.

In step 703, the AMF 313 notifies the TSCTSF/NEF 317 of the location and range information of the corresponding UE.

In step 704, the TSCTSF/NEF 317 reports the location and range information of the corresponding UE to the AF 501.

In step 704a, the AF 501 determines whether the location information of the UE satisfies requirements.

In step 704b, the AF 501 transmits the 5GS synchronization request message for the UE to the TSCTSF/NEF 317.

In step 705, the TSCTSF/NEF 317 determines whether the location information of the UE satisfies requirements.

In step 706, the TSCTSF/NEF 317 requests the UDM/UDR 316 to notify that there is a change in the subscription for the target UE, including the location information of the UE, so that the TSCTSF/NEF 317 may be notified of the changed information.

In step 706a, the UDM/UDR 316 requests the AMF 313 to notify that there is the change in the subscription for the target UE, including the location information of the UE.

In step 706b, in the case that there is the change in the subscription for the target UE, including the location information of the UE, the AMF 313 notifies the UDM/UDR 316 of the changed information.

In step 707, the TSCTSF/NEF 317 transmits the 5GS synchronization request for the UE 301 to the PCF 315. The request message may include the required synchronization accuracy as the sync error budget. In addition, the request message may specify the coverage to which the synchronization service is applied as the location or range.

In step 707a, the UDM/UDR 316 transmits the 5GS synchronization request message to the PCF 315 for the UE that satisfies the corresponding location or range condition. The request message may include the required synchronization accuracy as the sync error budget. In addition, the request message may specify the coverage to which the synchronization service is applied as the location or range.

In step 707b, the PCF 315 transmits the 5GS synchronization request for the UE that satisfies the location or range condition to the AMF 313. The request message may include the required synchronization accuracy as the sync error budget. In addition, the request message may specify the coverage to which the synchronization service is applied as the location or range.

In step 707c, the AMF 313 determines whether the location information of the UE satisfies requirements.

In step 707d, the AMF 313 requests the gNB 311 to apply the synchronization accuracy for the UE that satisfies the conditions. The request may include the synchronization accuracy as the sync error budget.

In step 707e, the gNB 311 may increase or decrease the SIB period based on the sync error budget information transmitted from the 5GC or may increase or decrease the delay time measurement period between the base station and the UE to measure the RRC TA value with each the UE, so that the SIB period or delay time measurement period can be controlled to satisfy the time synchronization accuracy requirements of the UE.

In step 708, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 708a, the UDM/UDR 316 transmits the 5GS synchronization request message for the UE 301 that satisfies the corresponding location or range condition to the PCF 315. The request message may include the required synchronization accuracy as a sync error budget. In addition, the request message may specify the coverage to which the synchronization service is applied as the location or range.

In step 708b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 708c, the SMF 314 requests the AMF 313 to notify that there is a change in the subscription for the target UE, including the location information of the UE, so that the SMF 314 may be notified the changes, and determine whether the location information of the UE satisfies requirements.

In step 708d, the SMF 314 transmits the 5GS time synchronization request for the corresponding UE to the AMF 313. The request may include the synchronization accuracy as the sync error budget.

In step 708e, when the UE is in an idle state, the AMF 313 may change the idle state of the UE into a connected state through a paging process.

In step 709, the AMF 313 transmits the 5GS time synchronization request message to the UE. The request message may include the synchronization accuracy as the sync error budget.

Thereafter, the UE may be provided with the 5GS time synchronization service according to the corresponding requirements.

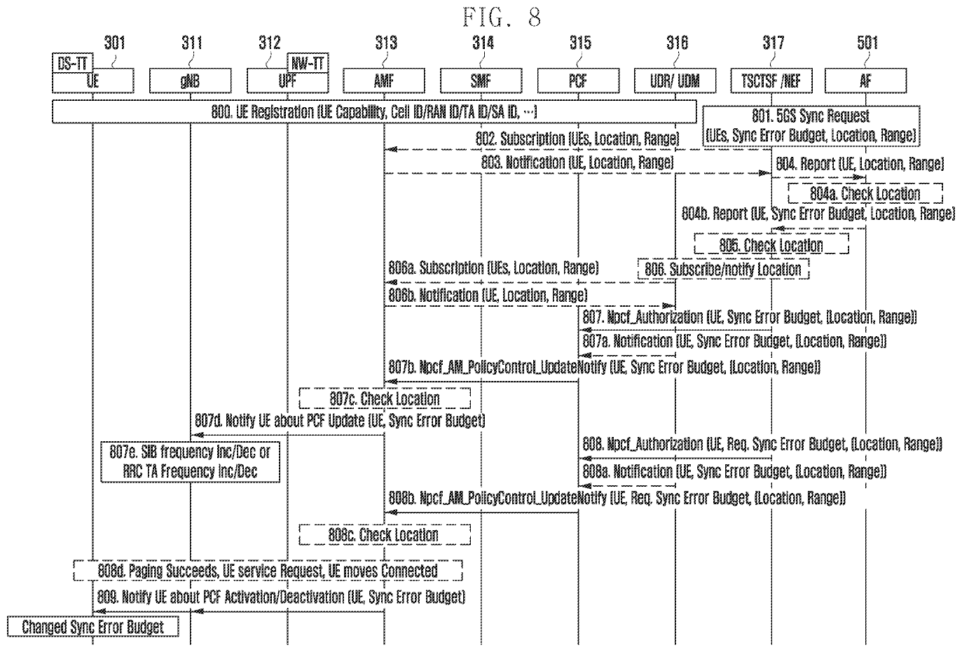

FIG. 8 illustrates a method in which a 5GC notifies an AF (TSCTSF/UDM/UDR/AMF) of a request and the AF (TSCTSF/UDM/UDR/AMF) transmits the request to a UE through AM NAS according to an embodiment.

More specifically, FIG. 8 illustrates a method in which a 5GC notifies an AF and the AF delivers SM to a terminal through NAS. The AF may include at least one of a TSCTSF, a UDM, a UDR, an AMF, or an SMF.

A message delivered to the UE through an AM NAS may include a control message related to the delivery of the sync message and information on how to use the information transmitted through air.

Referring to FIG. 8, in step 800, the UE 301 transmits a registration message including a UE Capability indicating that the UE may be supported by the 5GS synchronization service. The registration message may include a cell ID, a RAN ID, a tracking area ID, or an SA ID corresponding to where the UE 301 is located. Therefore, the NF receiving the registration message may derive the location of the UE from the cell ID, the RAN ID, the tracking area ID, or the SA ID.

In step 801, the AF 501 transmits the 5GS synchronization request message for target UEs to the TSCTSF/NEF 317. The request message may include the required synchronization accuracy as a sync error budget. In addition, the request message may specify a coverage to which the synchronization service is applied as a location or range. The indication of the target UE may be indicated as a list of UE IDs, a group ID, DNN/S-NSSAI, etc.

In step 802, the TSCTSF/NEF 317 requests the AMF 313 to notify the location and range information of the target UEs.

In step 803, the AMF 313 notifies the TSCTSF/NEF 317 of the location and range information of the corresponding UE.

In step 804, the TSCTSF/NEF 317 reports the location and range information of the corresponding UE to the AF 501.

In step 804a, the AF 501 determines whether the location information of the UE satisfies requirements.

In step 804b, the AF 501 transmits the 5GS synchronization request message for the UE to the TSCTSF/NEF 317.

In step 805, the TSCTSF/NEF 317 determines whether the location information of the UE satisfies requirements.

In step 806, the TSCTSF/NEF 317 requests the UDM/UDR 316 to notify that there is a change in the registration for the target UE, including the location information of the UE, so that the TSCTSF/NEF 317 may be notified of the changed information.

In step 806a, the UDM/UDR 316 requests the AMF 313 to notify that there is the change in the registration for the target UE, including the location information of the UE.

In step 806b, when there is the change in the registration for the target UE, including the location information of the UE, the AMF 313 notifies the UDM/UDR 316 of the changed information.

In step 807, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 807a, the UDM/UDR 316 transmits the 5GS synchronization request message to the PCF 315 for the UE that satisfies the corresponding location or range condition. The request message may include the required synchronization accuracy as the sync error budget. In addition, the request message may specify the coverage to which the synchronization service is applied as the location or range.

In step 807b, the PCF 315 transmits the 5GS synchronization request message for the UE that satisfies the location or range condition to the AMF 313. The request message may include the required synchronization accuracy as the sync error budget. In addition, the request message may specify the coverage to which the synchronization service is applied as the location or range.

In step 807c, the AMF 313 determines whether the location information of the UE satisfies requirements.

In step 807d, the AMF 313 requests the gNB 311 to apply the synchronization accuracy for the UE that satisfies the conditions. The request may include the synchronization accuracy as the sync error budget.

In step 807e, the gNB 311 may increase/decrease the SIB period based on the sync error budget information transmitted from the 5GC or may increase/decrease the delay time measurement period between the base station and the UE to measure the RRC TA value with each the UE, so that the SIB period or delay time measurement period can be controlled to satisfy the time synchronization accuracy requirements of the UE.

In step 808, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 808a, the UDM/UDR 316 transmits the 5GS synchronization request for the UE 301 that satisfies the corresponding location or range condition to the PCF 315. The request message may include the required synchronization accuracy as the sync error budget. In addition, the request message may specify the coverage to which the synchronization service is applied as the location or range.

In step 808b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 808c, the AMF 313 determines whether the location information of the UE satisfies requirements.

In step 808d, when the UE is in an idle state, the AMF 313 may change the idle state of the UE into a connected state through a paging process.

In step 809, the AMF 313 transmits the 5GS time synchronization request message to the UE. The request message may include the synchronization accuracy as the sync error budget.

Thereafter, the UE may be provided with the 5GS time synchronization service according to the corresponding requirements.

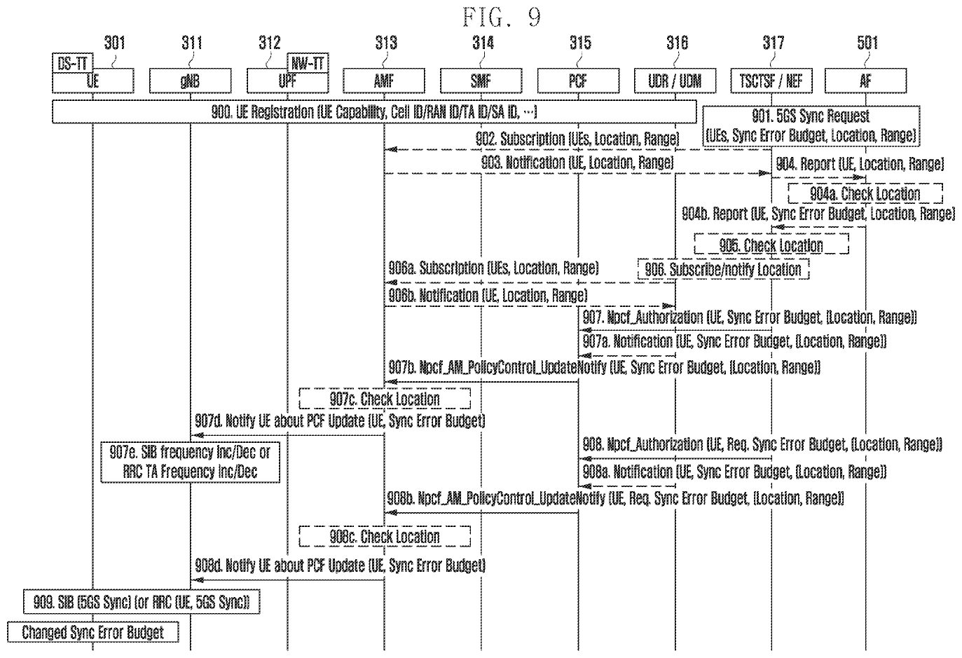

FIG. 9 illustrates a method in which a 5GC notifies an AF (TSCTSF/UDM/UDR/AMF) of a request and the AF (TSCTSF/UDM/UDR/AMF) transmits the request to a UE through AS (SIB or RRC signaling) according to an embodiment.

More specifically, FIG. 9 illustrates a method in which a 5GC notifies an AF and the AF delivers SM to a terminal through NAS. The AF may include at least one of a TSCTSF, a UDM, a UDR, an AMF, or an SMF.

In FIG. 9, the message delivered to the UE 301 through the AS (SIB or RRC signaling) may not include the control message related to the delivery of the synchronization message but may include information on how to use the information transmitted through air.

Referring to FIG. 9, in step 900, the UE 301 transmits a registration message including a UE Capability indicating that the UE may be supported by the 5GS synchronization service. The registration message may include a cell ID, a RAN ID, a tracking area ID, or an SA ID corresponding to where the UE 301 is located. Therefore, the NF receiving the subscription message may derive the location of the UE from the cell ID, the RAN ID, the tracking area ID, or the SA ID.

In step 901, the AF 501 transmits the 5GS synchronization request message for target UEs to the TSCTSF/NEF 317. The request message may include the required synchronization accuracy as a sync error budget. In addition, the request message may specify a coverage to which the synchronization service is applied as a location or range. The indication of the target UE may be indicated as a list of UE IDs, a group ID, DNN/S-NSSAI, etc.

In step 902, the TSCTSF/NEF 317 requests the AMF 313 to notify the location and range information of the target UEs.

In step 903, the AMF 313 notifies the TSCTSF/NEF 317 of the location and range information of the corresponding UE 301.

In step 904, the TSCTSF/NEF 317 reports the location and range information of the corresponding UE to the AF 501.

In step 904a, the AF 501 determines whether the location information of the UE satisfies requirements.

In step 904b, the AF 501 transmits the 5GS synchronization request message for the UE 301 to the TSCTSF/NEF 317.

In step 905, the TSCTSF/NEF 317 determines whether the location information of the UE 301 satisfies requirements.

In step 906, the TSCTSF/NEF 317 requests the UDM/UDR 316 to notify that there is a change in the subscription for the target UE 301, including the location information of the UE 301, so that the TSCTSF/NEF 317 may be notified of the changed information.

In step 906a, the UDM/UDR 316 requests the AMF 313 to notify that there is the change in the registration for the target UE, including the location information of the UE 301.

In step 906b, when there is the change in the registration for the target UE, including the location information of the UE 301, the AMF 313 notifies the UDM/UDR 316 of the changed information.

In step 907, the TSCTSF/NEF 317 transmits the 5GS synchronization request for the UE to the PCF 315. The request message may include the required synchronization accuracy as the sync error budget. In addition, the request message may specify the coverage to which the synchronization service is applied as the location or range.

In step 907a, the UDM/UDR 316 transmits the 5GS synchronization request to the PCF 315 for the UE 301 that satisfies the corresponding location or range condition. The request message may include the required synchronization accuracy as the sync error budget. In addition, the request message may specify the coverage to which the synchronization service is applied as the location or range.

In step 907b, the PCF 315 transmits the 5GS synchronization request for the UE 301 that satisfies the location or range condition to the AMF 313. The request message may include the required synchronization accuracy as the sync error budget. In addition, the request message may specify the coverage to which the synchronization service is applied as the location or range.

In step 907c, the AMF 313 determines whether the location information of the UE satisfies requirements.

In step 907d, the AMF 313 requests the gNB 311 to apply the synchronization accuracy for the UE 301 that satisfies the conditions. The request may include the synchronization accuracy as the sync error budget.

In step 907e, the gNB 311 may increase/decrease the SIB period based on the sync error budget information transmitted from the 5GC or may increase/decrease the delay time measurement period between the base station and the UE to measure the RRC TA value with each the UE, so that the SIB period or delay time measurement period can be controlled to satisfy the time synchronization accuracy requirements of the UE.

In step 908, the TSCTSF/NEF 317 transmits the 5GS synchronization request for the UE 301 to the PCF 315. Here, the request message may include the required synchronization accuracy as the sync error budget. In addition, the request message may specify the coverage to which the synchronization service is applied as the location or range.

In step 908a, the UDM/UDR 316 transmits the 5GS synchronization request for the UE that satisfies the corresponding location or range condition to the PCF 315. The request message may include the required synchronization accuracy as the sync error budget. In addition, the request message may specify the coverage to which the synchronization service is applied as the location or range.

In step 908b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 908c, the AMF 313 determines whether the location information of the UE satisfies requirements.

In step 908d, the AMF 313 requests the gNB 311 to apply the synchronization accuracy for the UE 301. The request may include the synchronization accuracy as the sync error budget.

In step 909, the gNB 311 transmits the 5GS time synchronization request message to the UE 301 The message may control the required synchronization accuracy as the sync error budget through the SIB or RRC.

Thereafter, the UE 301 may be provided with the 5GS time synchronization service according to the corresponding requirements.

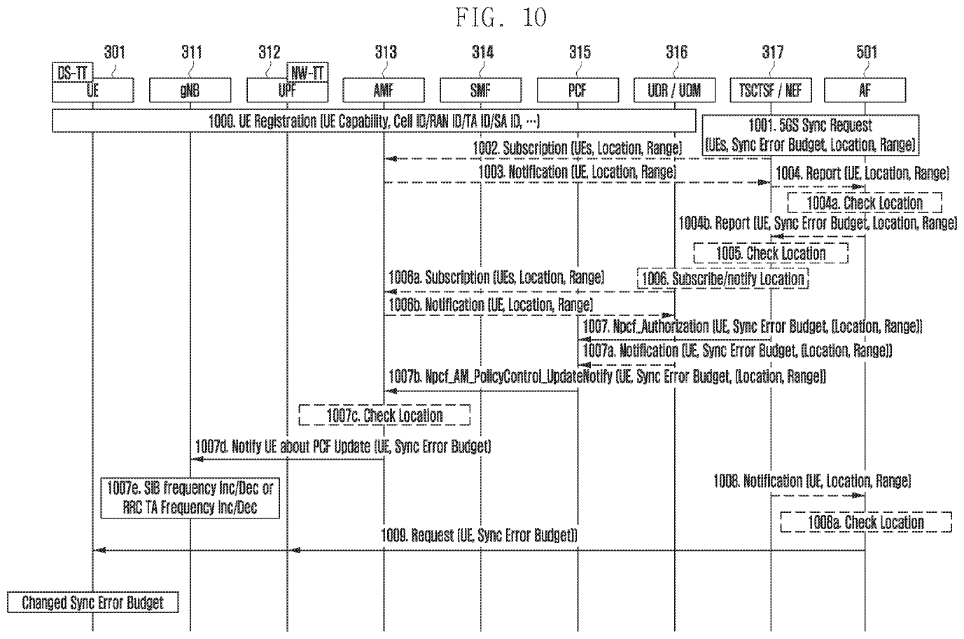

FIG. 10 illustrates a method in which a 5GC notifies an AF of a request and the AF transmits the request to a UE through a UP according to an embodiment.

More specifically, the AF may include at least one of a TSCTSF, a UDM, a UDR, an AMF, or an SMF.

In FIG. 10, the message delivered to the UE 301 through the UP may include the control message related to the delivery of the synchronization message and may include information on how to use the information transmitted through air. The UE 301 should interpret the message received from the UP to add a function for reflecting the interpretation to a synchronization message processing method and an air information processing process.

Referring to FIG. 10, in step 1000, the UE 301 transmits a registration message including UE Capability indicating that the UE may be supported by the 5GS synchronization service. The registration message may include a cell ID, a RAN ID, a tracking area ID, or an SA ID corresponding to where the UE is located. Therefore, the NF receiving the subscription message may derive the location of the UE from the cell ID, the RAN ID, the tracking area ID, or the SA ID.

In step 1001, the AF 501 transmits the 5GS synchronization request message for target UEs to the TSCTSF/NEF 317. The request message may include the required synchronization accuracy as a sync error budget. In addition, the request message may specify a coverage to which the synchronization service is applied as a location or range. The indication of the target UE may be indicated as a list of UE IDs, a group iD, DNN/S-NSSAI, etc.

In step 1002, the TSCTSF/NEF 317 requests the AMF 313 to notify the location and range information of the target UEs.

In step 1003, the AMF 313 notifies the TSCTSF/NEF 317 of the location and range information of the corresponding UE 301.

In step 1004, the TSCTSF/NEF 317 reports the location and range information of the corresponding UE 301 to the AF 501.

In step 1004a, the AF 501 determines whether the location information of the UE satisfies requirements.

In step 1004b, the AF 501 transmits the 5GS synchronization request message for the UE to the TSCTSF/NEF 317.

In step 1005, the TSCTSF/NEF 317 determines whether the location information of the UE 301 satisfies requirements.

In step 1006, the TSCTSF/NEF 317 requests the UDM/UDR 316 to notify that there is a change in the registration for the target UE 301, including the location information of the UE 301, so that the TSCTSF/NEF 317 may be notified of the changed information.

In step 1006a, the UDM/UDR 316 requests the AMF 313 to notify that there is the change in the registration for the target UE 301, including the location information of the UE.

In step 1006b, when there is the change in the subscription for the target UE 301, including the location information of the UE, the AMF 313 notifies the UDM/UDR 316 of the changed information.

In step 1007, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 1007a, the UDM/UDR 316 transmits the 5GS synchronization request message to the PCF 315 for the UE 301 that satisfies the corresponding location or range condition. The request message may include the required synchronization accuracy as the sync error budget. In addition, the request message may specify the coverage to which the synchronization service is applied as the location or range.

In step 1007b, the PCF 315 may transmit the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 1007c, the AMF 313 determines whether the location information of the UE 301 satisfies requirements.

In step 1007d, the AMF 313 requests the gNB 311 to apply the synchronization accuracy for the UE 301 that satisfies the conditions. The request may include the synchronization accuracy as the sync error budget.

In step 1007e, the gNB 311 may increase/decrease the SIB period based on the sync error budget information transmitted from the 5GC or may increase/decrease the delay time measurement period between the base station and the UE to measure the RRC TA value with each the UE, so that the SIB period or delay time measurement period can be controlled to satisfy the time synchronization accuracy requirements of the UE 301.

In step 1008, the TSCTSF/NEF 317 notifies the AF 501 of the location, range of the corresponding UE 301.

In step 1008a, the AF 501 determines whether the location information of the UE 301 satisfies requirements.

In step 1009, the AF 501 transmits the 5GS time synchronization request message to the UE 301 through the UP. The request message may include the required synchronization accuracy as the sync error budget.

Thereafter, the UE 301 may be provided with the 5GS time synchronization service according to the corresponding requirements.

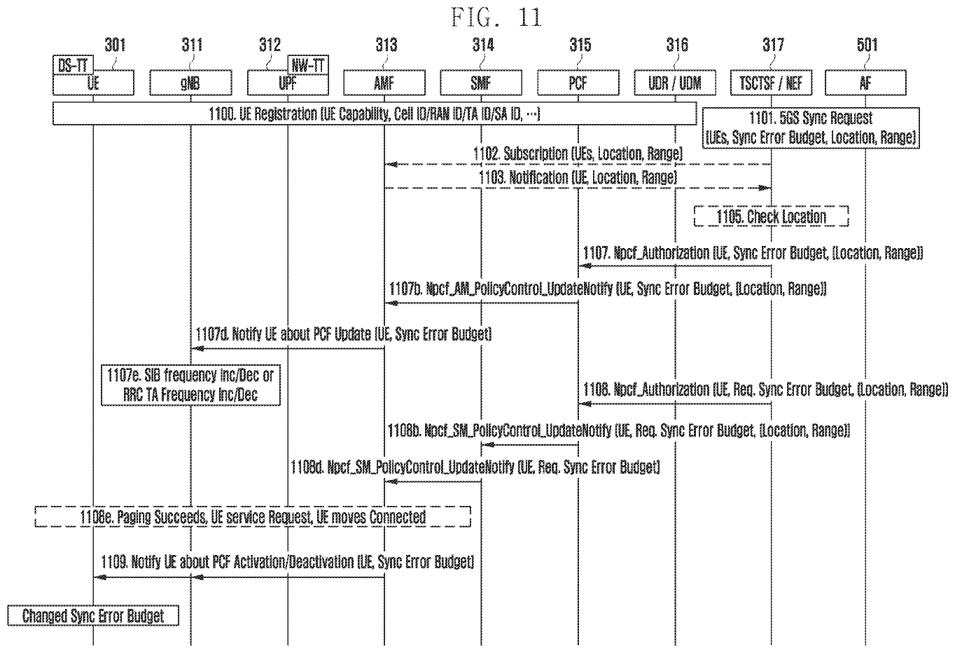

FIG. 11 illustrates a method in which a 5GC notifies a TSCTSF/NEF of a request and the TSCTSF/NEF transmits the request to a UE through SM NAS according to an embodiment.

In FIG. 11, the message delivered to the UE 301 through SM NAS may include the control message related to the delivery of the synchronization message.

Referring to FIG. 11, in step 1100, the UE 301 transmits a subscription message including a UE Capability indicating that the UE may be supported by the 5GS synchronization service. The registration message may include a cell ID, a RAN ID, a tracking area ID, or an SA ID corresponding to where the UE 301 is located. Therefore, the NF receiving the registration message may derive the location of the UE from the cell ID, the RAN ID, the tracking area ID, or the SA ID.

In step 1101, the AF 501 transmits the 5GS synchronization request message for target UEs to the TSCTSF/NEF 317. The request message may include the required synchronization accuracy as a sync error budget. In addition, the request message may specify a coverage to which the synchronization service is applied as a location or range. The indication of the target UE 301 may be indicated as a list of UE IDs, a group ID, DNN/S-NSSAI, etc.

In step 1102, the TSCTSF/NEF 317 requests the AMF 313 to notify the location and range information of the target UEs.

In step 1103, the AMF 313 notifies the TSCTSF/NEF 317 of the location and range information of the corresponding UE 301.

In step 1105, the TSCTSF/NEF 317 determines whether the location information of the UE 301 satisfies requirements.

In step 1107, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 1107b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 1107d, the AMF 313 requests the gNB 311 to apply the synchronization accuracy for the UE 301 that satisfies the conditions. The request may include the synchronization accuracy as the sync error budget.

In step 1107e, the gNB 311 may increase/decrease the SIB period based on the sync error budget information transmitted from the 5GC or may increase/decrease the delay time measurement period between the base station and the UE to measure the RRC TA value with the UE 301, so that the SIB period or delay time measurement period can be controlled to satisfy the time synchronization accuracy requirements of the UE 301.

In step 1108, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 1108b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 1108d, the SMF 314 transmits the 5GS time synchronization request for the corresponding UE 301 to the AMF 313. The request may include the required synchronization accuracy as the sync error budget.

In step 1108e, if the UE 301 is in an idle state, the AMF 313 may change the idle state of the UE 301 into a connected state through a paging process.

In step 1109, the AMF 313 transmits the 5GS time synchronization request to the UE 301. The request may include the required synchronization accuracy as the sync error budget.

Thereafter, the UE 301 may be provided with the 5GS time synchronization service according to the corresponding requirements.

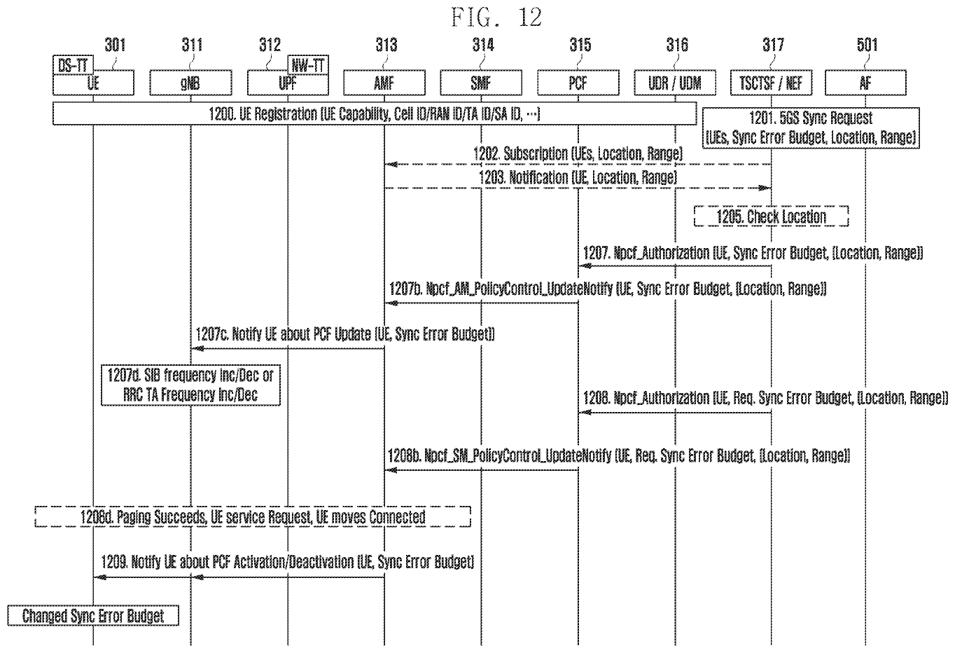

FIG. 12 illustrates a method in which a 5GC notifies a TSCTSF/NEF of a request and the TSCTSF/NEF transmits the request to a UE through AM NAS according to an embodiment.

In FIG. 12, the message delivered to the UE 301 through the AM NAS may include the control message related to the delivery of the synchronization message and may include information on how to use the information transmitted through air.

Referring to FIG. 12, in step 1200, the UE 301 transmits a registration message including a UE Capability indicating that the UE may be supported by the 5GS synchronization service. The registration message may include a cell ID, a RAN ID, a tracking area ID, or an SA ID corresponding to where the UE 301 is located. Therefore, the NF receiving the registration message may derive the location of the UE from the cell ID, the RAN ID, the tracking ID, or the SA ID.

In step 1201, the AF 501 transmits the 5GS synchronization request message for target UEs to the TSCTSF/NEF 317. The request message may include the required synchronization accuracy as a sync error budget. In addition, the request message may specify a coverage to which the synchronization service is applied as a location or range. The indication of the target UE 301 may be indicated as a list of UE IDs, a group ID, DNN/S-NSSAI, etc.

In step 1202, the TSCTSF/NEF 317 requests the AMF 313 to notify the location and range information of the target UEs.

In step 1203, the AMF 313 notifies the TSCTSF/NEF 317 of the location and range information of the corresponding UE 301.

In step 1205, the TSCTSF/NEF 317 determines whether the location information of the UE 301 satisfies requirements.

In step 1207, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 1207b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 1207c, the AMF 313 determines whether the location information of the UE 301 satisfies requirements.

In step 1207d, the AMF 313 requests the gNB 311 to apply the synchronization accuracy for the UE 301 that satisfies the conditions. The request may include the synchronization accuracy as the sync error budget.

In step 1207e, the gNB 311 may increase/decrease the SIB period based on the sync error budget information transmitted from the 5GC or may increase/decrease the delay time measurement period between the base station and the UE 301 to measure the RRC TA value with each the UE 301, so that the SIB period or delay time measurement period can be controlled to satisfy the time synchronization accuracy requirements of the UE 301.

In step 1208, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 1208b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 1208d, if the UE 301 is in an idle state, the AMF 313 may change the idle state of the UE 301 into a connected state through a paging process.

In step 1209, the AMF 313 transmits the 5GS time synchronization request to the UE. The request may include the required synchronization accuracy as the sync error budget.

Thereafter, the UE 301 may be provided with the 5GS time synchronization service according to the corresponding requirements.

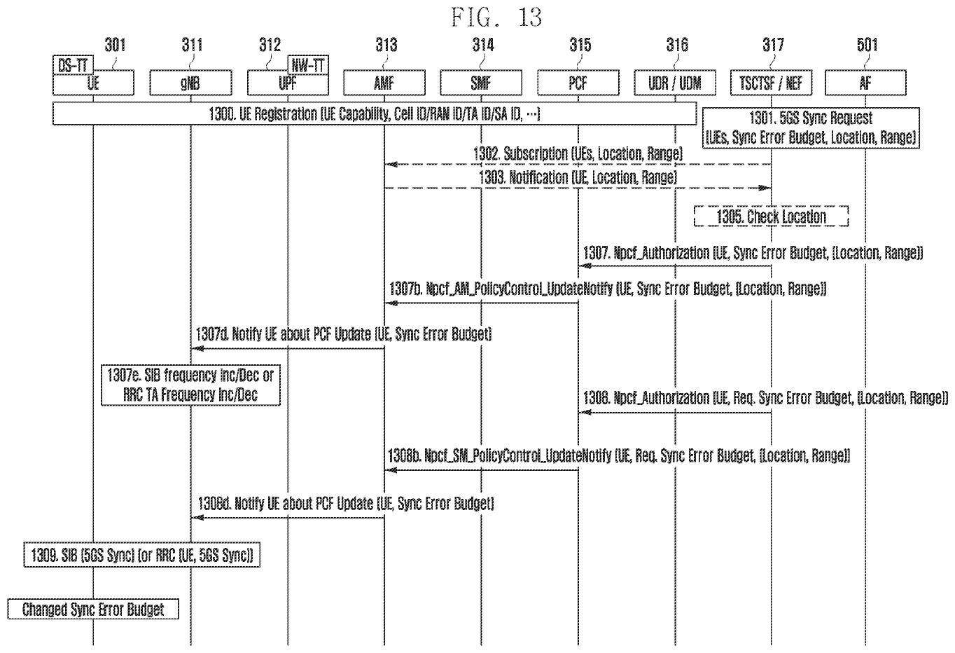

FIG. 13 illustrates a method in which a 5GC notifies a TSCTSF/NEF of a request and the TSCTSF/NEF transmits the request to a UE through AS (SIB or RRC signaling) according to an embodiment.

In FIG. 13, the message delivered to the UE 301 through the AS (SIB or RRC signaling) may not include the control message related to the delivery of the synchronization message but may include information on how to use the information transmitted through air.

Referring to FIG., 13, in step 1300, the UE 301 transmits a registration message including a UE Capability indicating that the UE may be supported by the 5GS synchronization service. The registration message may include a cell ID, a RAN ID, a tracking ID, or an SA ID corresponding to where the UE 301 is located. Therefore, the NF receiving the registration message may derive the location of the UE from the cell ID, the RAN ID, the tracking area ID, or the SA ID.

In step 1301, the AF 501 transmits the 5GS synchronization request message for target UEs to the TSCTSF/NEF 317. The request message may include the required synchronization accuracy as a sync error budget. In addition, the request message may specify a coverage to which the synchronization service is applied as a location or range. The indication of the target UE 301 may be indicated as a list of UE IDs, a group ID, DNN/S-NSSAI, etc.

In step 1302, the TSCTSF/NEF 317 requests the AMF 313 to notify the location and range information of the target UEs.

In step 1303, the AMF 313 notifies the TSCTSF/NEF 317 of the location and range information of the corresponding UE 301.

In step 1305, the TSCTSF/NEF 317 determines whether the location information of the UE 301 satisfies requirements.

In step 1307, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 1307b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 1307d, the AMF 313 requests the gNB 311 to apply the synchronization accuracy for the UE 301 that satisfies the conditions. The request may include the synchronization accuracy as the sync error budget.

In step 1307e, the gNB 311 may increase/decrease the SIB period based on the sync error budget information transmitted from the 5GC or may increase/decrease the delay time measurement period between the base station and the UE 301 to measure the RRC TA value with each the UE, so that the SIB period or delay time measurement period can be controlled to satisfy the time synchronization accuracy requirements of the UE 301.

In step 1308, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 1308b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 1308c, the AMF 313 determines whether the location information of the UE 301 satisfies requirements.

In step 1308d, the AMF 313 requests the gNB 311 to apply the synchronization accuracy for the UE 301 that satisfies conditions.

In step 1309, the gNB 311 transmits the 5GS time synchronization request message to the UE 301. The message may control the required synchronization accuracy as the sync error budget through an SIB or RRC.

Thereafter, the UE 301 may be provided with the 5GS time synchronization service according to the corresponding requirements.

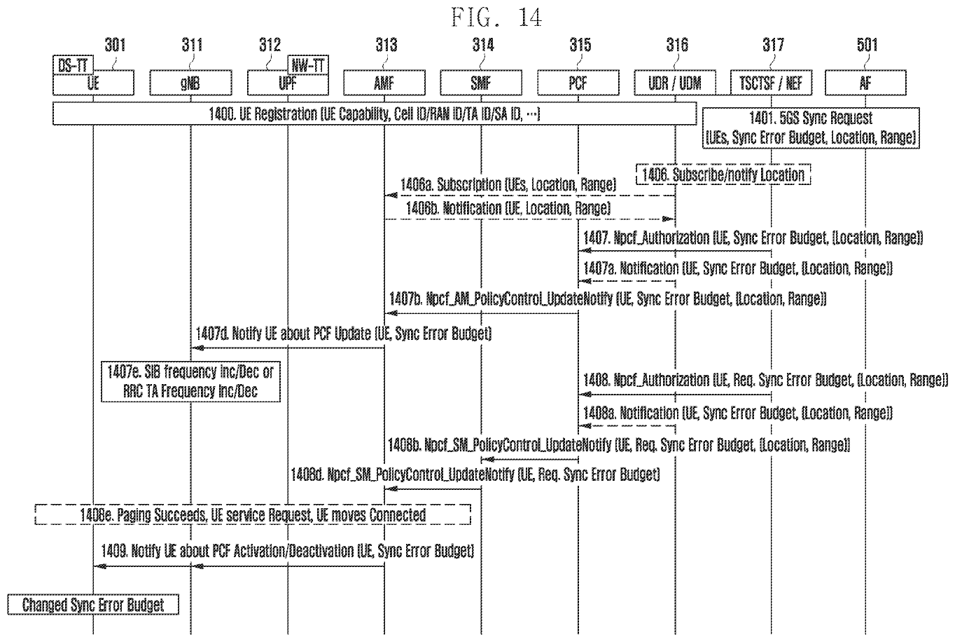

FIG. 14 illustrates a method in which a 5GC notifies UDM/UDR of a request and the UDM/UDR transmits the request to a UE through SM NAS according to an embodiment.

In FIG. 14, the message delivered to the UE through the SM NAS may include the control message related to the delivery of the synchronization message.

Referring to FIG. 14, in step 1400, the UE 301 transmits a registration message including a UE Capability indicating that the UE may be supported by the 5GS synchronization service. The registration message may include a cell ID, a RAN ID, a tracking area ID, or an SA ID corresponding to where the UE 301 is located. Therefore, the NF receiving the registration message may derive the location of the UE 301 from the cell ID, the RAN ID, the tracking area ID, or the SA ID.

In step 1401, the AF 501 transmits the 5GS synchronization request message for target UEs to the TSCTSF/NEF 317. The request message may include the required synchronization accuracy as a sync error budget. In addition, the request message may specify a coverage to which the synchronization service is applied as a location or range. The indication of the target UE 301 may be indicated as a list of UE IDs, a group ID, DNN/S-NSSAI, etc.

In step 1406, the TSCTSF/NEF 317 requests the UDM/UDR 316 to notify that there is a change in the registration for the target UE 301, including the location information of the UE 301, so that the TSCTSF/NEF 317 may be notified of the changed information.

In step 1406a, the UDM/UDR 316 requests the AMF 313 to notify the case that there is the change in the registration for the target UE 301, including the location information of the UE 301.

In step 1406b, when there is the change in the registration for the target UE 301, including the location information of the UE 301, the AMF 313 may notify the UDM/UDR 316 of the changed information.

In step 1407, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 1407a, the UDM/UDR 316 transmits the 5GS synchronization request message to the PCF 315 for the UE 301 that satisfies the corresponding location or range condition. The request message may include the required synchronization accuracy as the sync error budget. In addition, the request message may specify the coverage to which the synchronization service is applied as the location or range.

In step 1407b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 1407d, the AMF 313 requests the gNB 311 to apply the synchronization accuracy for the UE 301 that satisfies the conditions. The request may include the synchronization accuracy as the sync error budget.

In step 1407e, the gNB 311 may increase/decrease the SIB period based on the sync error budget information transmitted from the 5GC or may increase/decrease the delay time measurement period between the base station and the UE 301 to measure the RRC TA value with each the UE, so that the SIB period or delay time measurement period can be controlled to satisfy the time synchronization accuracy requirements of the UE 301.

In step 1408, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 1408a, the UDM/UDR 316 transmits the 5GS synchronization request message for the UE 301 that satisfies the corresponding location or range condition to the PCF 315. The request message may include the required synchronization accuracy as the sync error budget. In addition, the request message may specify the coverage to which the synchronization service is applied as the location or range.

In step 1408b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 1408d, the SMF transmits the 5GS time synchronization request message for the corresponding UE 301 to the AMF 313. The request message may include the required synchronization accuracy as the sync error budget.

In step 1408e, if the UE 301 is in an idle state, the AMF 313 may change the idle state of the UE 301 into a connected state through a paging process.

In step 1409, the AMF 313 transmits the 5GS time synchronization request message to the UE 301. The request message may include the required synchronization accuracy as the sync error budget.

Thereafter, the UE 301 may be provided with the 5GS time synchronization service according to the corresponding requirements.

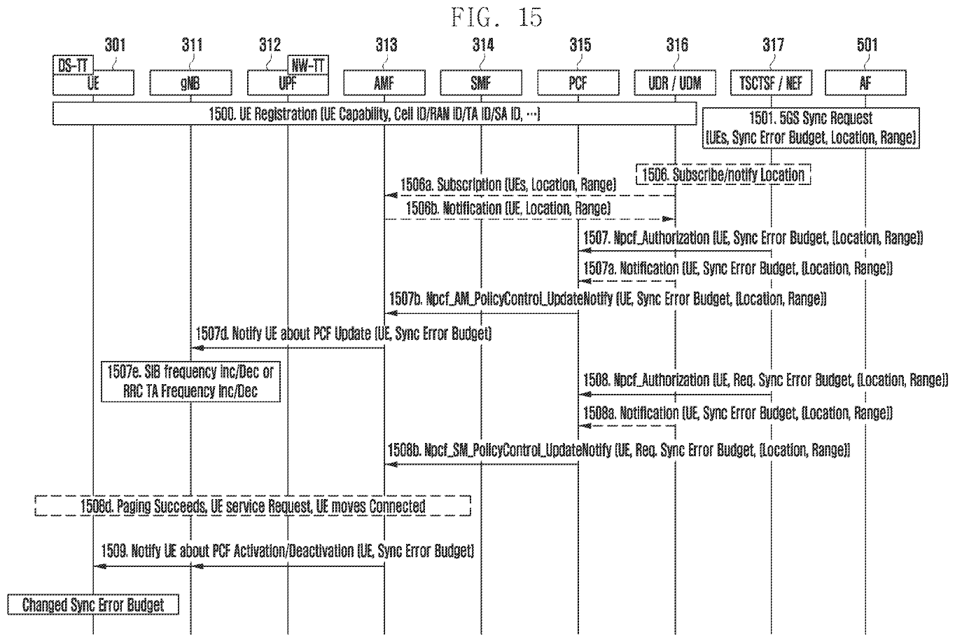

FIG. 15 illustrates a method in which a 5GC notifies a UDM/UDR of a request and the UDM/UDR transmits the request to a UE through AM NAS according to an embodiment.

In FIG. 15, the message delivered to the UE 301 through the AM NAS may include the control message related to the delivery of the synchronization message and may include information on how to use the information transmitted through air.

Referring to FIG. 15, in step 1500, the UE 301 transmits a registration message including a UE Capability indicating that the UE may be supported by the 5GS synchronization service. The registration message may include a cell ID, a RAN ID, a tracking area ID, or an SA ID corresponding to where the UE 301 is located. Therefore, the NF receiving the registration message may derive the location of the UE from the cell ID, the RAN ID, the tracking area ID, or the SA ID.

In step 1501, the AF 501 transmits the 5GS synchronization request message for target UEs to the TSCTSF/NEF 317. The request message may include the required synchronization accuracy as a sync error budget. In addition, the request message may specify a coverage to which the synchronization service is applied as a location or range. The indication of the target UE 301 may be indicated as a list of UE IDs, a group ID, DNN/S-NSSAI, etc.

In step 1506, the TSCTSF/NEF 317 requests the UDM/UDR 316 to notify that there is a change in the registration for the target UE 301, including the location information of the UE 301, so that the TSCTSF/NEF 317 may be notified of the changed information.

In step 1506a, the UDM/UDR 316 requests the AMF 313 to notify that there is a change in the registration for the target UE 301, including the location information of the UE 301.

In step 1506b, when there is the change in the registration for the target UE 301, including the location information of the UE 301, the AMF 313 may notify the UDM/UDR 316 of the changed information.

In step 1507, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 1507a, the UDM/UDR 316 transmits the 5GS synchronization request message to the PCF 315 for the UE 301 that satisfies the corresponding location or range condition. The request message may include the required synchronization accuracy as the sync error budget. In addition, the request message may specify the coverage to which the synchronization service is applied as the location or range.

In step 1507b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 1507d, the AMF 313 requests the gNB 311 to apply the synchronization accuracy for the UE 301 that satisfies the conditions. The request may include the synchronization accuracy as the sync error budget.

In step 1507e, the gNB 311 may increase/decrease the SIB period based on the sync error budget information transmitted from the 5GC or may increase/decrease the delay time measurement period between the base station and the UE 301 to measure the RRC TA value with each the UE, so that the SIB period or delay time measurement period can be controlled to satisfy the time synchronization accuracy requirements of the UE 301.

In step 1508, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 1508a, the UDM/UDR 316 transmits the 5GS synchronization request for the UE 301 that satisfies the corresponding location or range condition to the PCF 315. The request message may include the required synchronization accuracy as the sync error budget. In addition, the request message may specify the coverage to which the synchronization service is applied as the location or range.

In step 1508b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 1508d, if the UE 301 is in an idle state, the AMF 313 may change the idle state of the UE 301 into a connected state through a paging process.

In step 1509, the AMF 313 transmits the 5GS time synchronization request message to the UE 301. The request message may include the required synchronization accuracy as the sync error budget.

Thereafter, the UE 301 may be provided with the 5GS time synchronization service according to the corresponding requirements.

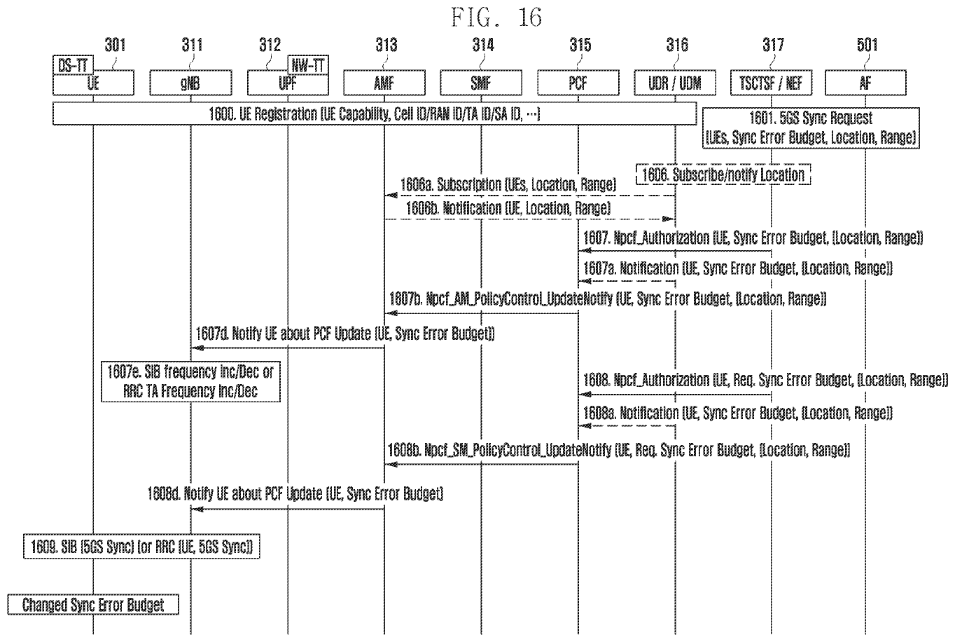

FIG. 16 illustrates a method in which a 5GC notifies a UDM/UDR of a request and the UDM/UDR transmits the request to a UE through AS (SIB or RRC signaling) according to an embodiment.

In FIG. 16, the message delivered to the UE 301 through the AS (SIB or RRC signaling) may not include the control message related to the delivery of the synchronization message but may include information on how to use the information transmitted through air.

Referring to FIG. 16, in step 1600, the UE 301 transmits a subscription message including a UE Capability indicating that the UE 301 may be supported by the 5GS synchronization service. The registration message may include a cell ID, a RAN ID, a tracking area ID, or an SA ID corresponding to where the UE 301 is located. Therefore, the NF receiving the registration message may derive the location of the UE from the cell ID, the RAN ID, the tracking area ID, or the SA ID.

In step 1601, the AF 501 transmits the 5GS synchronization request message for target UEs to the TSCTSF/NEF 317. The request message may include the required synchronization accuracy as a sync error budget. In addition, the request message may specify a coverage to which the synchronization service is applied as a location or range. The indication of the target UE 301 may be indicated as a list of UE IDs, a group ID, DNN/S-NSSAI, etc.

In step 1606, the TSCTSF/NEF 317 requests the UDM/UDR 316 to notify that there is a change in the registration for the target UE 301, including the location information of the UE 301, so that the TSCTSF/NEF 317 may be notified of the changed information.

In step 1606a, the UDM/UDR 316 requests the AMF 313 to notify that there is a change in the registration for the target UE 301, including the location information of the UE 301.

In step 1606b, when there is the change in the registration for the target UE 301, including the location information of the UE 301, the AMF 313 may notify the UDM/UDR 316 of the changed information.

In step 1607, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 1607a, the UDM/UDR 316 may transmit the 5GS synchronization request message to the PCF 315 for the UE 301 that satisfies the corresponding location or range condition. The request message may include the required synchronization accuracy as the sync error budget. In addition, the request message may specify the coverage to which the synchronization service is applied as the location or range.

In step 1607b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 1607d, the AMF 313 requests the gNB 311 to apply the synchronization accuracy for the UE 301 that satisfies the conditions. The request may include the synchronization accuracy as the sync error budget.

In step 1607e, the gNB 311 may increase/decrease the SIB period based on the sync error budget information transmitted from the 5GC or may increase/decrease the delay time measurement period between the base station and the UE 301 to measure the RRC TA value with each the UE, so that the SIB period or delay time measurement period can be controlled to satisfy the time synchronization accuracy requirements of the UE 301.

In step 1608, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 1608a, the UDM/UDR 316 transmits the 5GS synchronization request for the UE 301 that satisfies the corresponding location or range condition to the PCF 315. The request message may include the required synchronization accuracy as the sync error budget. In addition, the request message may specify the coverage to which the synchronization service is applied as the location or range.

In step 1608b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 1608d, the AMF 313 requests the gNB 311 to apply the synchronization accuracy for the UE 301 that satisfies conditions. The request may include the synchronization accuracy as the sync error budget.

In step 1609, the gNB 311 transmits the 5GS time synchronization request to the UE 301. The request may control the required synchronization accuracy as the sync error budget through the SIB or RRC.

Thereafter, the UE 301 may be provided with the 5GS time synchronization service according to the corresponding requirements.

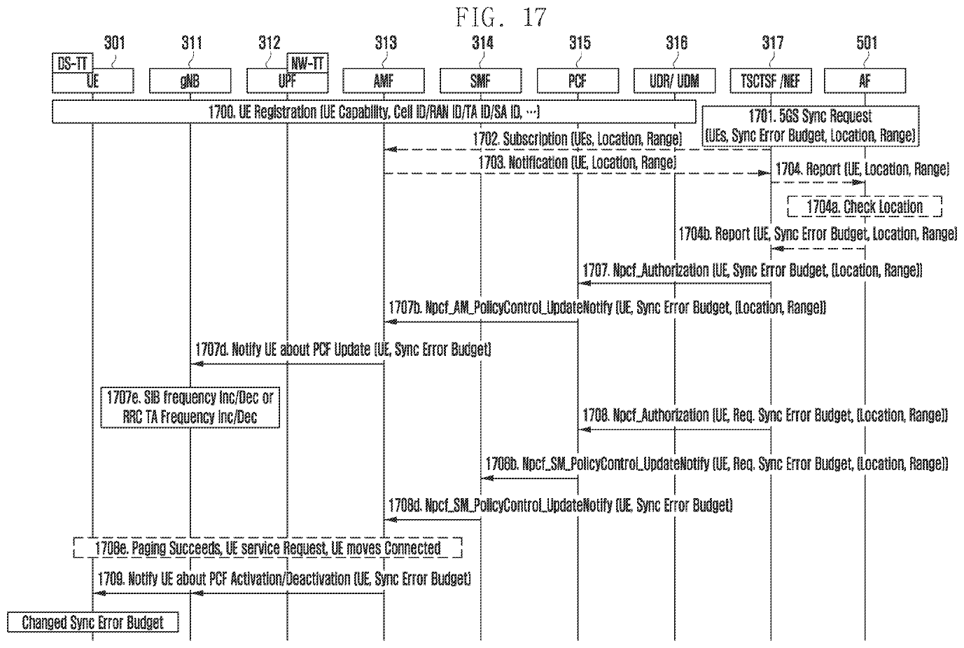

FIG. 17 illustrates a method in which a 5GC notifies an AF of a request and the AF transmits the request to a UE through SM NAS according to an embodiment.

In FIG. 17, the message delivered to the UE 301 through the SM NAS may include the control message related to the delivery of the synchronization message.

Referring to FIG. 17, in step 1700, the UE 301 transmits a registration message including a UE Capability indicating that the UE may be supported by the 5GS synchronization service. The registration message may include a cell ID, a RAN ID, a tracking area ID, or an SA ID corresponding to where the UE 301 is located. Therefore, the NF receiving the registration message may derive the location of the UE from the cell ID, the RAN ID, the tracking area ID, or the SA ID.

In step 1701, the AF 501 transmits the 5GS synchronization request message for target UEs to the TSCTSF/NEF 317. The request message may include the required synchronization accuracy as a sync error budget. In addition, the request message may specify a coverage to which the synchronization service is applied as a location or range. The indication of the target UE 301 may be indicated as a list of UE IDs, a group ID, DNN/S-NSSAI, etc.

In step 1702, the TSCTSF/NEF 317 requests the AMF 313 to notify the location and range information of the target UEs.

In step 1703, the AMF 313 notifies the TSCTSF/NEF 317 of the location and range information of the corresponding UE 301.

In step 1704, the TSCTSF/NEF 317 reports the location and range information of the corresponding UE 301 to the AF 501.

In step 1704a, the AF 501 determines whether the location information of the UE 301 satisfies requirements.

In step 1704b, the AF 501 transmits the 5GS synchronization request message for the UE 301 to the TSCTSF/NEF 317.

In step 1707, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 1707b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 1707d, the AMF 313 requests the gNB 311 to apply the synchronization accuracy for the UE 301 that satisfies the conditions. The request may include the synchronization accuracy as the sync error budget.

In step 1707e, the gNB 311 may increase/decrease the SIB period based on the sync error budget information transmitted from the 5GC or may increase/decrease the delay time measurement period between the base station and the UE 301 to measure the RRC TA value with each the UE, so that the SIB period or delay time measurement period can be controlled to satisfy the time synchronization accuracy requirements of the UE 301.

In step 1708, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 1708b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 1708d, the SMF transmits the 5GS time synchronization request for the corresponding UE 301 to the AMF 313. The request may include the required synchronization accuracy as the sync error budget.

In step 1708e, if the UE 301 is in an idle state, the AMF 313 may change the idle state of the UE 301 into a connected state through a paging process.

In step 1709, the AMF 313 transmits the 5GS time synchronization request to the UE 301. The request may include the required synchronization accuracy as the sync error budget.

Thereafter, the UE 301 may be provided with the 5GS time synchronization service according to the corresponding requirements.

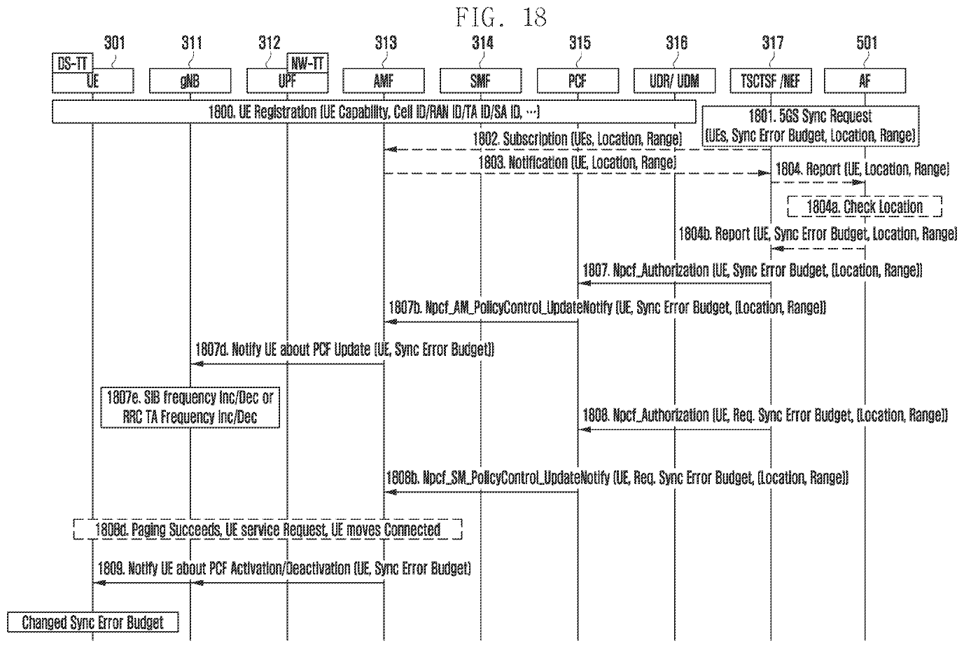

FIG. 18 illustrates a method in which a 5GC notifies an AF of a request and the AF transmits the request to a UE through AM NAS according to an embodiment.

In FIG. 128, the message delivered to the UE 301 through the AM NAS may include the control message related to the delivery of the synchronization message and may include information on how to use the information transmitted through air.

Referring to FIG. 18, in step 1800, the UE 301 transmits a registration message including a UE Capability indicating that the UE may be supported by the 5GS synchronization service. The registration message may include a cell ID, a RAN ID, a tracking area ID, or an SA ID corresponding to where the UE 301 is located. Therefore, the NF receiving the registration message may derive the location of the UE from the cell ID, the RAN ID, the tracking area ID, or the SA ID.

In step 1801, the AF 501 transmits the 5GS synchronization request message for target UEs to the TSCTSF/NEF 317. The request message may include the required synchronization accuracy as a sync error budget. In addition, the request message may specify a coverage to which the synchronization service is applied as a location or range. The indication of the target UE 301 may be indicated as a list of UE IDs, a group ID, DNN/S-NSSAI, etc.

In step 1802, the TSCTSF/NEF 317 requests the AMF 313 to notify the location and range information of the target UEs.

In step 1803, the AMF 313 notifies the TSCTSF/NEF 317 of the location and range information of the corresponding UE 301.

In step 1804, the TSCTSF/NEF 317 reports the location and range information of the corresponding UE 301 to the AF 501.

In step 1804a, the AF 501 determines whether the location information of the UE 301 satisfies requirements.

In step 1804b, the AF 501 transmits the 5GS synchronization request message for the UE 301 to the TSCTSF/NEF 317.

In step 1807, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 1807b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 1807d, the AMF 313 requests the gNB 311 to apply the synchronization accuracy for the UE 301 that satisfies the conditions. The request may include the synchronization accuracy as the sync error budget.

In step 1807e, the gNB 311 may increase/decrease the SIB period based on the sync error budget information transmitted from the 5GC or may increase/decrease the delay time measurement period between the base station and the UE 301 to measure the RRC TA value with each the UE, so that the SIB period or delay time measurement period can be controlled to satisfy the time synchronization accuracy requirements of the UE 301.

In step 1808, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 1808b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 1808d, if the UE 301 is in an idle state, the AMF 313 may change the idle state of the UE 301 into a connected state through a paging process.

In step 1809, the AMF 313 transmits the 5GS time synchronization request message to the UE 301. The 5GS time synchronization request message may include the synchronization accuracy requested as the sync error budget.

Thereafter, the UE 301 may be provided with the 5GS time synchronization service according to the corresponding requirements.

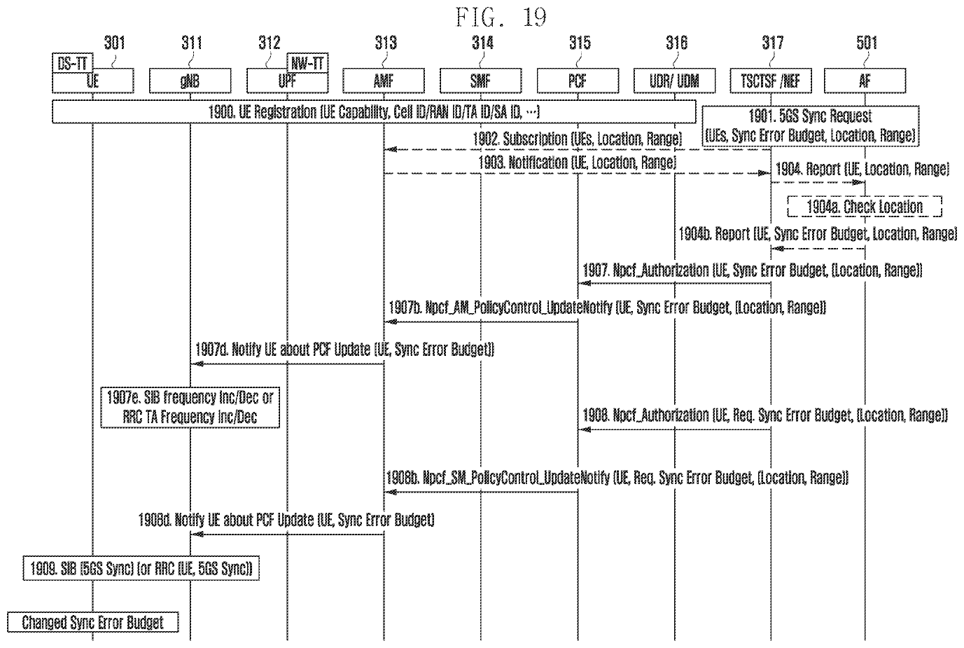

FIG. 19 illustrates a method in which a 5GC notifies an AF of a request and the AF transmits the request to a UE through AS (SIB or RRC signaling) according to an embodiment.

In FIG. 19, the message delivered to the UE 301 through the AS (SIB or RRC signaling) may not include the control message related to the delivery of the synchronization message but may include information on how to use the information transmitted through air.

Referring to FIG. 19, in step 1900, the UE 301 may transmit a registration message including a UE Capability indicating that the UE may be supported by the 5GS synchronization service. The registration message may include a cell ID, a RAN ID, a tracking area ID, or an SA ID corresponding to where the UE 301 is located. Therefore, the NF receiving the registration message may derive the location of the UE from the cell ID, the RAN ID, the tracking area ID, or the SA ID.

In step 1901, the AF 501 transmits the 5GS synchronization request message for target UEs to the TSCTSF/NEF 317. The request message may include the required synchronization accuracy as a sync error budget. In addition, the request message may specify a coverage to which the synchronization service is applied as a location or range.

The indication of the target UE 301 may be indicated as a list of UE IDs, a group ID, DNN/S-NSSAI, etc.

In step 1902, the TSCTSF/NEF 317 requests the AMF 313 to notify the location and range information of the target UEs.

In step 1903, the AMF 313 notifies the TSCTSF/NEF 317 of the location and range information of the corresponding UE 301.

In step 1904, the TSCTSF/NEF 317 reports the location and range information of the corresponding UE 301 to the AF 501.

In step 1904a, the AF 501 determines whether the location information of the UE 301 satisfies requirements.

In step 1904b, the AF 501 transmits the 5GS synchronization request message for the UE 301 to the TSCTSF/NEF 317.

In step 1907, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 1907b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 1907d, the AMF 313 transmits, to the gNB 311, a message for requesting the application of the synchronization accuracy for the UE 301 that satisfies the conditions. The message for requesting the synchronization accuracy application may include the synchronization accuracy as the sync error budget.

In step 1907e, the gNB 311 may increase/decrease the SIB period based on the sync error budget information transmitted from the 5GC or may increase/decrease the delay time measurement period between the base station and the UE 301 to measure the RRC TA value with each the UE, so that the SIB period or delay time measurement period can be controlled to satisfy the time synchronization accuracy requirements of the UE 301.

In step 1908, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 1908b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 1908d, the AMF 313 requests the gNB 311 to apply the synchronization accuracy for the UE 301 that satisfies conditions. The request may include the synchronization accuracy as the sync error budget.

In step 1909, the gNB 311 transmits the 5GS time synchronization request to the UE 301. The request may control the required synchronization accuracy as the sync error budget through the SIB or RRC.

Thereafter, the UE 301 may be provided with the 5GS time synchronization service according to the corresponding requirements.

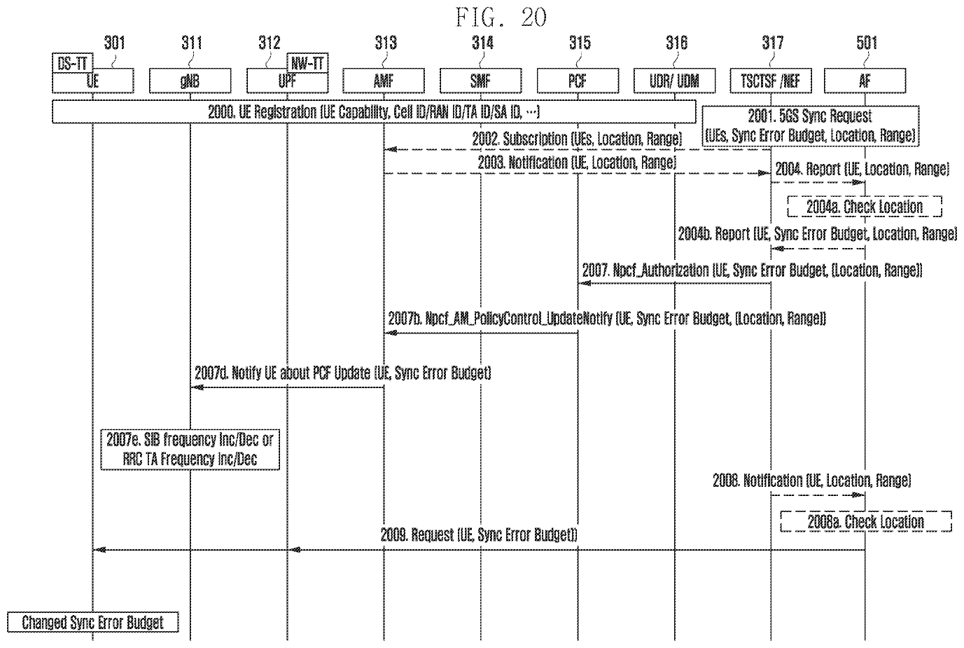

FIG. 20 illustrates a method in which a 5GC notifies an AF of a request and the AF transmits the request to a UE through a UP according to an embodiment.

In FIG. 20, the message delivered to the UE 301 through the UP may include the control message related to the delivery of the synchronization message and may include information on how to use the information transmitted through air. The UE 301 should interpret the message received from the UP to add a function for reflecting the interpretation to a synchronization message processing method and an air information processing process.

Referring to FIG. 20, in step 2000, the UE 301 transmits a registration message including a UE Capability indicating that the UE may be supported by the 5GS synchronization service. The registration message may include a cell ID, a RAN ID, a tracking area ID, or an SA ID corresponding to where the UE 301 is located. Therefore, the NF receiving the registration message may derive the location of the UE from the cell ID, the RAN ID, the tracking area ID, or the SA ID.

In step 2001, the AF 501 transmits the 5GS synchronization request message for target UEs to the TSCTSF/NEF 317. The request message may include the required synchronization accuracy as a sync error budget. In addition, the request message may specify a coverage to which the synchronization service is applied as a location or range. The indication of the target UE 301 may be indicated as a list of UE IDs, a group ID, DNN/S-NSSAI, etc.

In step 2002, the TSCTSF/NEF 317 requests the AMF 313 to notify the location and range information of the target UEs.

In step 2003, the AMF 313 notifies the TSCTSF/NEF 317 of the location and range information of the corresponding UE 301.

In step 2004, the TSCTSF/NEF 317 reports the location and range information of the corresponding UE 301 to the AF 501.

In step 2004a, the AF 501 determines whether the location information of the UE 301 satisfies requirements.

In step 2004b, the AF 501 transmits the 5GS synchronization request message for the UE 301 to the TSCTSF/NEF 317.

In step 2007, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 2007b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 2007d, the AMF 313 transmits, to the gNB 311, a message for requesting the application of the synchronization accuracy for the UE 301 that satisfies the conditions.

The message for requesting the synchronization accuracy application may include the synchronization accuracy as the sync error budget.

In step 2007e, the gNB 311 may increase/decrease the SIB period based on the sync error budget information transmitted from the 5GC or may increase/decrease the delay time measurement period between the base station and the UE 301 to measure the RRC TA value with each the UE, so that the SIB period or delay time measurement period can be controlled to satisfy the time synchronization accuracy requirements of the UE 301.

In step 2008, the TSCTSF/NEF 317 notifies the AF 501 of the location, range of the corresponding UE 301.

In step 2008a, the AF 501 determines whether the location information of the UE 301 satisfies requirements.

In step 2009, the AF 501 transmits the 5GS time synchronization request message to the UE 301 through the UP. The 5GS time synchronization request message may include the required synchronization accuracy as the sync error budget.

Thereafter, the UE 301 may be provided with the 5GS time synchronization service according to the corresponding requirements.

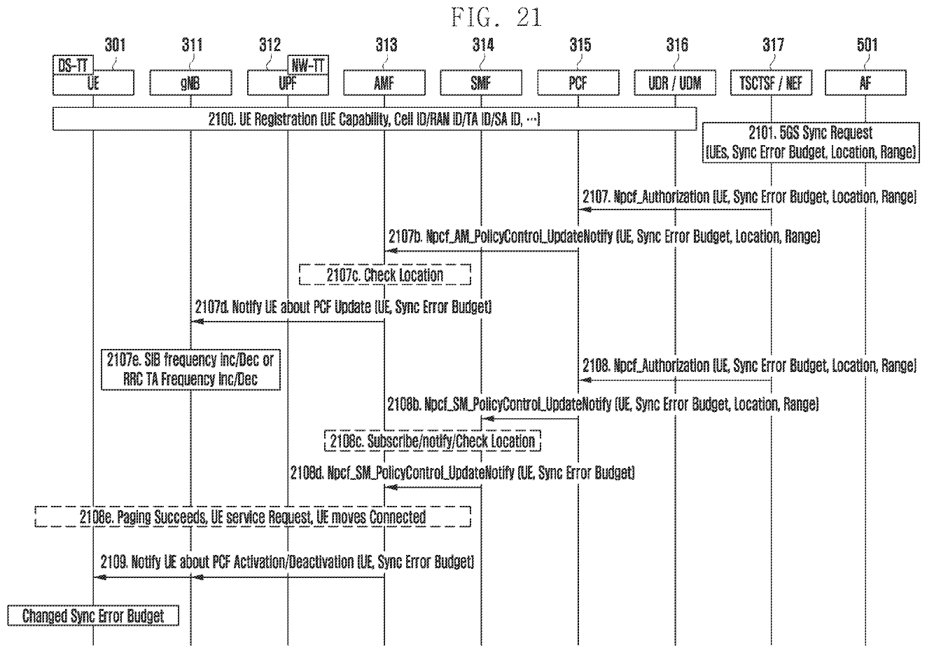

FIG. 21 illustrates a method in which a 5GC notifies an AMF/SMF of a request and the AMF/SMF transmits the request to a UE through SM NAS according to an embodiment.

In FIG. 21, the message delivered to the UE 301 through the SM NAS may include the control message related to the delivery of the synchronization message.

Referring to FIG. 21, in step 2100, the UE 301 transmits a registration message including a UE Capability indicating that the UE may be supported by the 5GS synchronization service. The registration message may include a cell ID, a RAN ID, a tracking area ID, or an SA ID corresponding to where the UE 301 is located. Therefore, the NF receiving the registration message may derive the location of the UE from the cell ID, the RAN ID, the tracking area ID, or the SA ID.

In step 2101, the AF 501 transmits the 5GS synchronization request message for target UEs to the TSCTSF/NEF 317. The request message may include the required synchronization accuracy as a sync error budget. In addition, the request message may specify a coverage to which the synchronization service is applied as a location or range. The indication of the target UE 301 may be indicated as a list of UE IDs, a group ID, DNN/S-NSSAI, etc.

In step 2107, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 2107b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 2107c, the AMF 313 determines whether the location information of the UE 301 satisfies requirements.

In step 2107d, the AMF 313 transmits, to the gNB 311, a message for requesting the application of the synchronization accuracy for the UE 301 that satisfies the conditions. The message may include the synchronization accuracy as the sync error budget.

In step 2107e, the gNB 311 may increase/decrease the SIB period based on the sync error budget information transmitted from the 5GC or may increase/decrease the delay time measurement period between the base station and the UE 301 to measure the RRC TA value with each the UE, so that the SIB period or delay time measurement period can be controlled to satisfy the time synchronization accuracy requirements of the UE 301.

In step 2108, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 2108a, the UDM/UDR 316 transmits the 5GS synchronization request for the UE 301 that satisfies the corresponding location or range condition to the PCF 315. The request message may include the required synchronization accuracy as the sync error budget. In addition, the request message may specify the coverage to which the synchronization service is applied as the location or range.

In step 2108b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 2108c, the SMF 314 requests the AMF 313 to notify that there is a change in the subscription for the target UE 301, including the location information of the UE 301, so that the SMF 314 may be notified of the changed information and determine whether the location information of the UE 301 satisfies requirements.

In step 2108d, the SMF 314 transmits the 5GS time synchronization request message for the corresponding UE 301 to the AMF 313. The request message may include the required synchronization accuracy as the sync error budget.

In step 2108e, if the UE 301 is in an idle state, the AMF 313 may change the idle state of the UE 301 into a connected state through a paging process.

In step 2109, the AMF 313 transmits the 5GS time synchronization request message to the UE 301. The request message may include the required synchronization accuracy as the sync error budget.

Thereafter, the UE 301 may be provided with the 5GS time synchronization service according to the corresponding requirements.

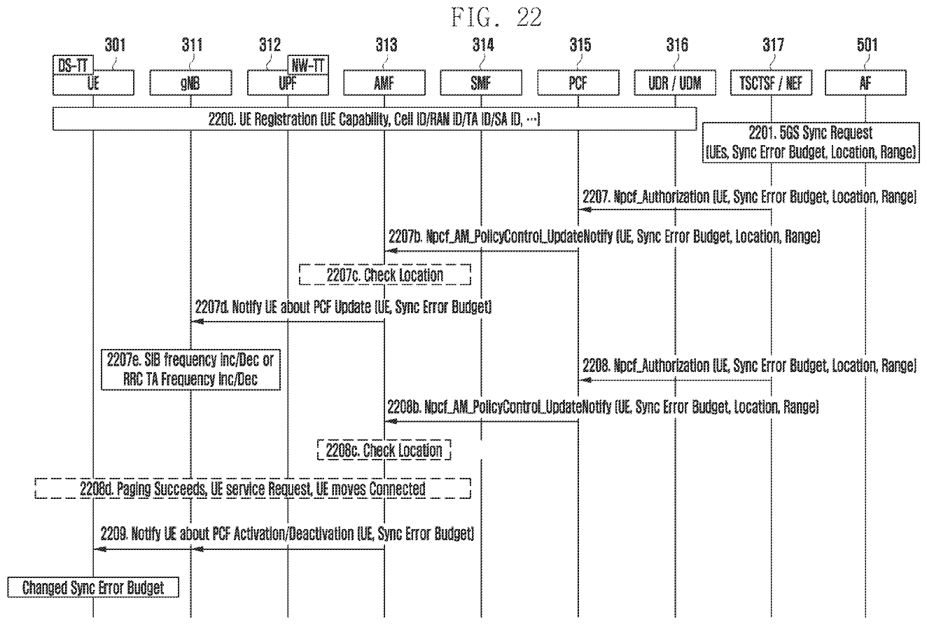

FIG. 22 illustrates a method in which a 5GC notifies an AMF/SMF of a request and the AMF/SMF transmits the request to a UE through AM NAS according to an embodiment.

In FIG. 22, the message delivered to the UE 301 through the AM NAS may include the control message related to the delivery of the synchronization message and may include information on how to use the information transmitted through air.

Referring to FIG. 22, in step 2200, the UE 301 transmits a registration message including a UE Capability indicating that the UE may be supported by the 5GS synchronization service. The registration message may include a cell ID, a RAN ID, a tracking area ID, or an SA ID corresponding to where the UE 301 is located. Therefore, the NF receiving the registration message may derive the location of the UE from the cell ID, the RAN ID, the tracking area ID, or the SA ID.

In step 2201, the AF 501 transmits the 5GS synchronization request message for target UEs to the TSCTSF/NEF 317. The request message may include the required synchronization accuracy as a sync error budget. In addition, the request message may specify a coverage to which the synchronization service is applied as a location or range. The indication of the target UE 301 may be indicated as a list of UE IDs, a group ID, DNN/S-NSSAI, etc.

In step 2207, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 2207b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 2207c, the AMF 313 determines whether the location information of the UE 301 satisfies requirements.

In step 2207d, the AMF 313 requests the gNB 311 to apply the synchronization accuracy for the UE 301 that satisfies the conditions. The request may include the synchronization accuracy as the sync error budget.

In step 2207e, the gNB 311 may increase/decrease the SIB period based on the sync error budget information transmitted from the 5GC or may increase/decrease the delay time measurement period between the base station and the UE 301 to measure the RRC TA value with each the UE, so that the SIB period or the delay time measurement period can be controlled to satisfy the time synchronization accuracy requirements of the UE 301.

In step 2208, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 2208b, the PCF 315 may transmit the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 2208c, the AMF 313 may determine whether the location information of the UE satisfies requirements.

In step 2208d, if the UE 301 is in an idle state, the AMF 313 may change the idle state of the UE 301 into a connected state through a paging process.

In step 2209, the AMF 313 transmits the 5GS time synchronization request message to the UE 301. The request message may include the required synchronization accuracy as the sync error budget.

Thereafter, the UE 301 may be provided with the 5GS time synchronization service according to the corresponding requirements.

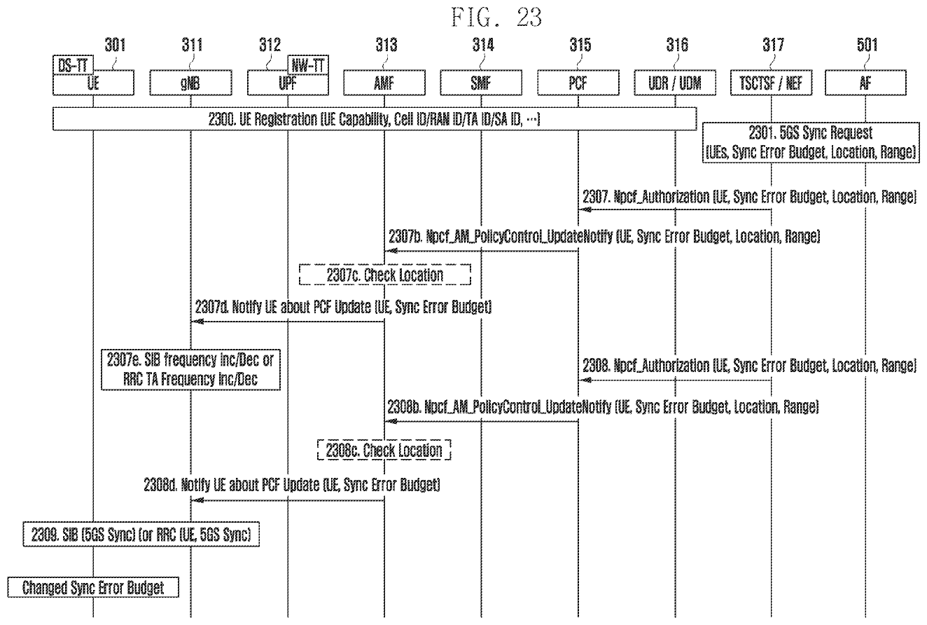

FIG. 23 illustrates a method in which a 5GC notifies an AMF/SMF of a request and the AMF/SMF transmits the request to a UE through AS (SIB or RRC signaling) according to an embodiment.

In FIG. 23, the message delivered to the UE 301 through the AS (SIB or RRC signaling) may not include the control message related to the delivery of the synchronization message but may include information on how to use the information transmitted through air.

Referring to FIG. 23, in step 2300, the UE 301 transmits a registration message including a UE Capability indicating that the UE may be supported by the 5GS synchronization service. The registration message may include a cell ID, a RAN ID, a tracking area ID, or an SA ID corresponding to where the UE 301 is located. Therefore, the NF receiving the registration message may derive the location of the UE from the cell ID, the RAN ID, the tracking area ID, or the SA ID.

In step 2301, the AF 501 transmits the 5GS synchronization request message for target UEs to the TSCTSF/NEF 317. The request message may include the required synchronization accuracy as a sync error budget. In addition, the request message may specify a coverage to which the synchronization service is applied as a location or range. The indication of the target UE 301 may be indicated as a list of UE IDs, a group ID, DNN/S-NSSAI, etc.

In step 2307, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 2307b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 2307c, the AMF 313 determines whether the location information of the UE 301 satisfies requirements.

In step 2307d, the AMF 313 requests the gNB 311 to apply the synchronization accuracy for the UE 301 that satisfies the conditions. The request may include the synchronization accuracy as the sync error budget.

In step 2307e, the gNB 311 may increase/decrease the SIB period based on the sync error budget information transmitted from the 5GC or may increase/decrease the delay time measurement period between the base station and the UE 301 to measure the RRC TA value with each the UE, so that the SIB period or delay time measurement period can be controlled to satisfy the time synchronization accuracy requirements of the UE 301.

In step 2308, the TSCTSF/NEF 317 transmits the 5GS synchronization request message for the UE 301 to the PCF 315. The request message may include the required synchronization accuracy as the sync error budget. In addition, the request message may specify the coverage to which the synchronization service is applied as the location or range.

In step 2308b, the PCF 315 transmits the 5GS synchronization request message for the UE 301 that satisfies the location or range condition to the AMF 313. The request message may include the required synchronization accuracy as the sync error budget. In addition, the request message may specify the coverage to which the synchronization service is applied as the location or range.

In step 2308c, the AMF 313 determines whether the location information of the UE 301 satisfies requirements.

In step 2308d, the AMF 313 requests the gNB 311 to apply the synchronization accuracy for the UE 301 that satisfies conditions. The request may include the synchronization accuracy as the sync error budget.

In step 2309, the gNB 311 transmits the 5GS time synchronization request to the UE 301. The message may control the required synchronization accuracy as the sync error budget through the SIB or RRC.

Thereafter, the UE 301 may be provided with the 5GS time synchronization service according to the corresponding requirements.

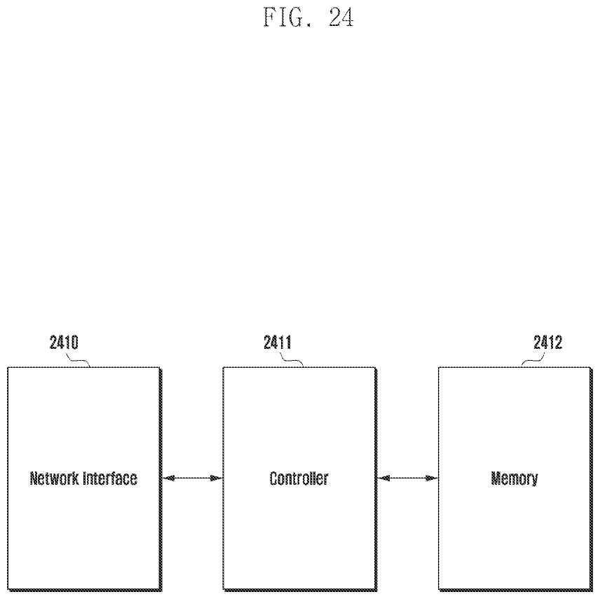

FIG. 24 illustrates an NF of a wireless communication network according to an embodiment.

Referring to FIG. 24, a network interface 2410 may communicate with at least one TSN node and/or other network entities of a mobile communication core network. For example, if the NF is the RAN, the NF may perform communication with the UPF, the AMF, etc. As another example, if the NF is the UPF, the NF may perform communication with the RAN, the SMF, etc. Similarly, if the NF is a specific network entity, the network interface 2410 may communicate with another entity of the mobile communication network and/or at least one node of the TSN system. Accordingly, the network interface 2410 may include a function of NW-TT in a specific case, e.g., in case that the network interface 2410 is included in the UPF.

A controller 2411 may be implemented into at least one processor and/or a program for performing an NF operation. For example, if the NF is the UPF, the controller 2411 may perform the above-described operations of the NEF. As another example, the NF may perform the AMF operations described in FIGS. 7 to 23, instead of the AMF. Other network entities may perform the control necessary for the above-described operations in the same manner.

The memory 2412 may store programs and various control information for use by the controller 2411, and store each information described in the disclosure.

In addition to the configuration described above, the NF may further include various interfaces for access with an operator. In the disclosure, there is no particular limitation on such an additional configuration.

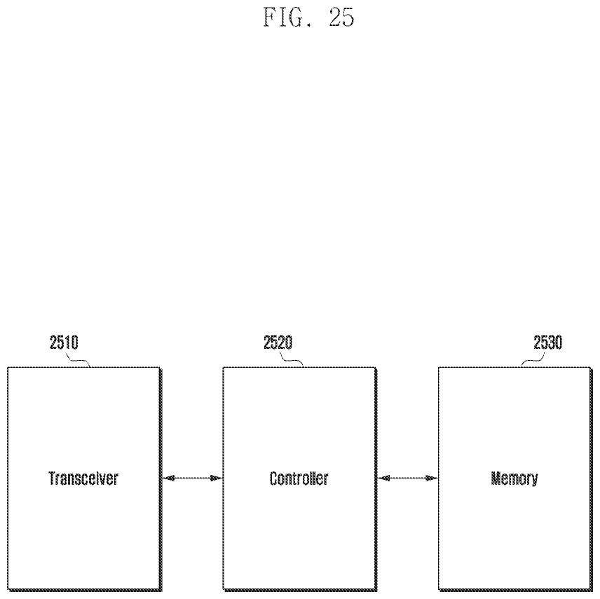

FIG. 25 illustrates a UE according to an embodiment.

Referring to FIG. 25, a UE 301 includes a transceiver 2510, a controller 2520, and a memory 2530. The UE 301 may additionally have more components according to an implementation method. For example, the UE 301 may further include various additional devices such as a display for a user interface, an input unit, and a sensor. In the disclosure, no restrictions are placed on such an additional configuration.

The transceiver 2510 may be connected to a base station through a wireless channel based on each of the embodiments described in FIGS. 1 to 23, and may transmit and receive signals and/or messages to and from the base station. If the UE communicates with the 5G network, the transceiver 2510 may be a device capable of transmitting and receiving signals and/or messages to and from the 5G communication network. Further, the transceiver 2510 may include a communication processor. If the transceiver 2510 does not include a communication processor, all signals and/or messages may be processed by the controller.

Further, according to the disclosure, the transceiver 2510 may communicate with at least one node of the TSN system. In this case, at least one node of the TSN system may be a bridge for transmitting data to the next node in TSN as described above. Therefore, the transceiver 2510 according to the disclosure may include both a configuration for communicating with a mobile communication system in a wireless format and a configuration for DS-TT.

The controller 2520 may control a basic operation of the UE 301, and control reception, delivery, transmission, and storage of the messages described above.

The memory 2530 may store various data for the control of the UE 301, and have an area for storing a message received from a specific NF of the core network and/or the base station in order to communicate using the network slice described above.

Methods according to the embodiments described in the claims or specifications of the disclosure may be implemented in the form of hardware, software, or a combination of hardware and software.

When implemented in software, a computer readable storage medium storing one or more programs (software modules) may be provided. One or more programs stored in the computer readable storage medium are configured for execution by one or more processors in an electronic device. The one or more programs include instructions for causing an electronic device to execute methods according to embodiments described in a claim or specification of the disclosure.

Such programs (software modules, software) may be stored in a random access memory, a non-volatile memory including a flash memory, a read only memory (ROM), an electrically erasable programmable ROM (EEPROM), a magnetic disc storage device, a compact disc-ROM (CD-ROM), digital versatile discs (DVDs), any other form of optical storage device, or a magnetic cassette. Alternatively, the programs may be stored in a memory configured with a combination of some or all thereof. Further, each configuration memory may be included in the plural.

Further, the program may be stored in an attachable storage device that may access through a communication network such as the Internet, Intranet, local area network (LAN), wide LAN (WLAN), or storage area Network (SAN), or a communication network configured with a combination thereof. Such a storage device may access to a device implementing an embodiment of the disclosure through an external port. Further, a separate storage device on a communication network may access a device implementing the embodiment of the disclosure.

In the specific embodiments of the disclosure described above, elements included in the disclosure are expressed in the singular or plural according to the specific embodiments presented. However, the singular or plural expression is appropriately selected for a situation presented for convenience of description, and the disclosure is not limited to the singular or plural components, and even if a component is represented in the plural, it may be configured with the singular, or even if a component is represented in the singular, it may be configured with the plural.

According to the above-described embodiments of the disclosure, if a mobile communication system operates as a TSN node, it is possible to determine whether a service is provided to a terminal in the mobile communication system based on the coverage of the base station. Therefore, in the case of applying the disclosure, there is an advantage in providing a more stable service when TSN is supported in the mobile communication system.

While the disclosure has been particularly shown and described with reference to certain embodiments thereof, it will be understood by those of ordinary skill in the art that various changes in form and details may be made therein without departing from the spirit and scope of the disclosure as defined by the following claims and their equivalents.

What is claimed is:

1. A method performed by a first entity that performs a time sensitive communication time synchronization function (TSCTSF) in a wireless communication system, the method comprising:
receiving, from an entity that performs an external application function (AF), a first service synchronization request message including information for performing service synchronization;
obtaining location information of a terminal to perform the service synchronization; and
determining whether to support a synchronization service based on the first service synchronization request message and the location information of the terminal to perform the synchronization.

2. The method of claim 1, wherein obtaining the location information of the terminal comprises:
transmitting, to a second entity that performs an access and mobility management function (AMF), a request message for the location information of the terminal; and
receiving, from the second entity, a location information response message including the location information of the terminal to perform the 5GS synchronization.

3. The method of claim 1, wherein the information for performing the first service synchronization includes at least one of synchronization accuracy information, synchronization location information, synchronization coverage information, or terminal identification information, and
wherein the location information of the terminal includes at least one of a location of the terminal and a range of the terminal.

4. The method of claim 1, wherein the service synchronization includes 5G service (5GS) synchronization.

5. A method performed by a second entity that performs an access and mobility management function (AMF) in a wireless communication system, the method comprising:
receiving, from a first entity that performs a time sensitive communication time synchronization function (TSCTSF), a request message for location information of a terminal;
transmitting, to the first entity, a response message including the location information of the terminal to perform service synchronization;
receiving, from a third entity that performs a policy control management function (PCF), a second service synchronization request message; and
determining whether to perform a synchronization service for the terminal based on the location information of the terminal to perform the service synchronization.

6. The method of claim 5, wherein in response determining to perform the synchronization service for the terminal, the method further comprises transmitting a first service synchronization application request message to a base station,
wherein the first service synchronization application request message includes synchronization accuracy related information, and
wherein at least one of a system information block (SIB) transmission period and a timing advance value is determined based on the synchronization accuracy related information.

7. The method of claim 5, wherein in response to determining to perform the synchronization service for the terminal, the method further comprises transmitting a second service synchronization application request message to the terminal,
wherein the second service synchronization application request message includes synchronization accuracy related information, and
wherein the 5GS synchronization service is applied based on the synchronization accuracy related information.

8. The method of claim 5, further comprising receiving, from the terminal, a registration request message for the service synchronization service,
wherein the registration request message includes at least one of a cell identifier to which the terminal belongs, a base station identifier, a tracking area identifier, or a service area identifier.

9. The method of claim 5, further comprising:
receiving, from a fourth entity that performs a user data repository (UDR), a registration change request message including the location information of the terminal;
determining whether registration of the terminal has changed; and
transmitting, to the fourth entity, a registration change response message including the changed location information of the terminal, in response to determining that the registration of the terminal has changed.

10. The method of claim 5, wherein the service synchronization includes 5G service (5GS) synchronization.

11. A first entity that performs a time sensitive communication time synchronization function (TSCTSF) in a wireless communication system, the first entity comprising:
a transceiver; and
a controller configured to:
receive, from an entity that performs an external application function (AF), via the transceiver, a first service synchronization request message including information for performing service synchronization,
obtain location information of a terminal to perform the service synchronization, and
determine whether to support a synchronization service based on the first service synchronization request message and the location information of the terminal to perform the service synchronization.

12. The first entity of claim 11, wherein the controller is further configured to:
transmit, via the transceiver, a request message for the location information of the terminal to a second entity that performs an access and mobility management function (AMF), and
receive, from the from the second entity, via the transceiver, a location information response message including the location information of the terminal to perform the service synchronization.

13. The first entity of claim 11, wherein information for performing the first service synchronization includes at least one of synchronization accuracy information, synchronization location information, synchronization coverage information, or terminal identification information, and
wherein the location information of the terminal includes at least one of a location of the terminal and a range of the terminal.

14. The first entity of claim 11, wherein the service synchronization includes 5G service (5GS) synchronization.

15. A second entity that performs an access and mobility management function (AMF) in a wireless communication system, the second entity comprising:
a transceiver; and
a controller configured to:
receive, from a first entity that performs a time sensitive communication time synchronization function (TSCTSF), via the transceiver, a request message for location information of a terminal,
transmit, to the first entity that performs the TSCTSF, via the transceiver, a request response message including the location information of the terminal to perform service synchronization,
receive, from a third entity that performs a policy control management function (PCF), via the transceiver, a second service synchronization request message, and
determine whether to perform a synchronization service for the terminal based on the location information of the terminal to perform the service synchronization.

16. The second entity of claim 15, wherein in response to determining to perform the synchronization service for the terminal, the controller is further configured to transmit a first service synchronization application request message to a base station,
wherein the first service synchronization application request message includes synchronization accuracy related information, and
wherein at least one of a system information block (SIB) transmission period and a timing advance value is determined based on the synchronization accuracy related information.

17. The second entity of claim 15, wherein in response to determining to perform the synchronization service for the terminal, the controller is further configured to transmit a second service synchronization application request message to the terminal,
wherein the second service synchronization application request message includes synchronization accuracy related information, and
wherein the synchronization service is applied based on the synchronization accuracy related information.

18. The second entity of claim 15, wherein the controller is further configured to receive a registration request message for the service synchronization service from the terminal, and
wherein the registration request message includes at least one of a cell identifier to which the terminal belongs, a base station identifier, a tracking area identifier, or a service area identifier.

19. The second entity of claim 15, wherein the controller is further configured to:
receive from a fourth entity that performs a user data repository (UDR), a registration change request message including the location information of the terminal,
determine whether registration of the terminal has changed, and
in response to determining that the registration of the terminal has changed, transmit, to the fourth entity, a registration change response message including the changed location information of the terminal.

20. The second entity of claim 15, wherein the service synchronization includes 5G service (5GS) synchronization.
